(19) United States
(12) Patent Application Publication
(10) Pub. No.: US 2025/0005669 A1
(43) Pub. Date: Jan. 2, 2025

(54) OPTIMIZED COST BASIS CALCULATIONS VIA MATCHING OFFSETTING ATOMIC PRIMITIVE OPERATIONS

(71) Applicant: Mark MUELLER-EBERSTEIN, Bellevue, WA (US)

(72) Inventor: Mark MUELLER-EBERSTEIN, Bellevue, WA (US)

(21) Appl. No.: 18/215,689

(22) Filed: Jun. 28, 2023

(51) Int. Cl. G06Q 40/06

(52) U.S. Cl. CPC G06Q 40/06; G06Q 2220/00

(57) ABSTRACT

Methods, systems, and apparatus, including computer programs encoded on a computer storage medium, for implementing cost basis optimization include a computing device that assigns a transaction identifier to a financial transaction on an asset, identifies an action and related information corresponding to the financial transaction, and generates component operations that effect the action. The component operations are matched to carry out the action. The computing device further selects a cost basis method related to one of the operations, calculates a cost basis for the transaction using the cost basis method, iterates over the selecting of a cost basis method and calculating a cost basis using the selected cost basis method for a set number of iterations, and selects one of the calculated cost basis methods based on a predetermined criterion.

### BACKGROUND

Enterprises such as exchange entities may handle a large number of financial transactions daily. As technology advances, cryptocurrency is being used increasingly, on and off the blockchain, as payment for goods and services for both domestic and international transfers, and in a new and evolving suite of protocols known as “Decentralized Finance” (DeFi) as “Non-Fungible Tokens” (NFTs), allowing complex transactions such as borrowing and lending, on-chain exchanges, and synthetic assets. Associated with the increasing use of cryptocurrency is a complicated calculation of tax liabilities and generation of financial reports for subscribers and/or government entities.

Accordingly, there is a need for improving the confidence in the accuracy and auditability of recording financial transactions involving cryptocurrency, and creating compliant records and reports of financial transactions, on and off blockchain.

### BRIEF DESCRIPTION OF THE DRAWINGS

The detailed description is described with reference to the accompanying figures, in which the left-most digit(s) of a reference number identifies the figure in which the reference number first appears. The use of the same reference numbers in different figures indicates similar or identical items.

FIG. 1 illustrates a schematic view of an example computing architecture that implements a platform for establishing a cost basis calculation based on atomic primitive operations.

FIG. 2 illustrates a block diagram that shows a receiving and storing of external data to a database.

FIG. 3 illustrates a block diagram that shows an example implementation for pre-processing transaction data to facilitate generation of a report.

FIG. 4 illustrates a block diagram of an example trade action that includes selling and buying of assets over a particular time period.

FIG. 5 is a block diagram of an example FTPC server that implements the improving of the cost basis calculation based on atomic primitive operations.

FIG. 6 is a swimlane diagram illustrating an example cost basis calculation over financial transactions (or trading actions) incurred by a subscriber in a tax year.

FIG. 7 is a flow diagram that depicts an example process for at least one aspect of the techniques for implementing the platform for improving a cost basis calculation based on atomic primitive operations.

FIG. 8 is a flow diagram that depicts an example procedure for at least one aspect of the techniques for selecting the adjusted cost basis value that can be used to determine, for example, a capital gain resulting from a transaction.

FIG. 9 is a flow diagram of an example procedure for selecting the cost basis for an asset involved in a transaction using different sets of actions to decompose the transaction.

FIG. 10 is a flow diagram of an example procedure 1000 for determining the optimal or near-optimal cost basis for an asset involved in a transaction using different sets of actions to decompose the transaction.

### DETAILED DESCRIPTION

This disclosure is directed to the analysis of asset transactions and subsequent use of the analysis results for financial tabulations, report generation, and regulatory compliance, including but not limited to calculations that optimize, or aim to optimize, tax status related to blockchain transactions. In some embodiments, the asset transactions may involve cryptocurrency and other transactions stored in a blockchain. Analysis may be performed by a platform on data stored in various blockchains to identify various transactions. In some embodiments, financial transactions that have tax consequences are analyzed to determine various actions that make up each transaction and one or more atomic operation primitives that make up each action.

For example, transactions can be decomposed into matched atomic primitive operations, such as buy operations and sell operations for an asset transfer. More than one technique can be employed in matching operations, such as, and without limitation: FIFO (first in, first-out), LIFO (last in, first out), specific Identification, and manual override, described herein.

In some implementations, one or more atomic primitive operations may be analyzed to determine content for a requested financial report. In one embodiment, the platform may receive a subscriber request for a financial report such as a profit-and-loss (PnL) report, fees report, a debt report, or a holdings report. In response to the receiving of the subscriber request, the platform may retrieve from a database corresponding transaction data that relates to at least one action involving one or more assets from a financial transaction. The platform may then generate zero, one or more atomic primitive operations that compose at least part of the action and use generated operation(s) to determine content (e.g., taxable income, fees) for the financial report. In some examples, an action or actions may generate no operations on the asset, such as in the instance of a failed transaction, which may be represented by a transaction object containing an action that does not generate operations. In one instance, the generated one or more atomic primitive operations may be used to calculate a cost basis, and/or adjustment to the cost basis, to increase the purchase price or decrease the sales price for an asset by, e.g., comparing results from different cost basis methods, to achieve favorable tax treatment with respect to the transaction. The platform may store the content into the database and/or transmit the content as, e.g., a financial report, formatted and unformatted “report data”, including as “Application Programming Interface” API call response to the subscriber or a third party such as a banking institution, tax agency, tax or accounting software, or the like.

As described herein, the action may include a transitioning of states by the asset in accordance, for example, with a smart contract protocol or workflow. The state may represent an instance while the transitioning of states can represent the atomic primitive operation(s) of the action where the instance can change its state. In one embodiment, the action involving one or more assets may include a trading action such as selling and buying assets, a discarding action such as donating the asset, a minting action such as mining or receiving an asset in an airdrop, a depositing or withdrawing action, a borrowing action, a payback action, an asset transfer-out action, and/or an asset transfer-in action. Here, the action may generate one or more atomic primitive operations, which can be representative of components of the action.

For example, the generated components (or atomic primitive operations) from the action may include a buying of an asset (referred to as a BuyOp), selling of the asset (referred to as SellOp), borrowing of the asset (referred to as BorrowOp), paying back of an account (referred to as PaybackOp), discarding of the asset as if nothing is received (referred to as DiscardOp), and adjusting of cost basis (referred to as AdjustOp), earning or losing an amount (positive or negative) of a fiat reference currency (USD in this example) (referred to as USDEarnOp, representing a taxable gain (loss)), and/or receiving USD (referred to as USDReceiveOp, representing a non-taxable receipt of USD). Each of these components, or in combination with one or more different components, may be used to generate the content of the financial report. In one embodiment, the platform may perform a pre-processing of the transaction data in multiple passes that can include generation and matching of the atomic primitive operations regardless of type of requested report from the subscriber. In another embodiment, the platform may perform the pre-processing of the transaction data upon detection of a triggering event such as receiving of a new data upload or a subscriber request for a particular report. In some other embodiment, the platform may perform the pre-processing of the transaction data during a preconfigured interval such as every minute, hour, etc.

The platform may include software, hardware, or a combination thereof, to leverage the use of the atomic primitive operations to facilitate the generation of the financial report as described herein. To receive the financial data from the different external sources such as blockchain-based financial transactions (e.g., Ethereum, Bitcoin), centralized and decentralized exchange and entities exported data (e.g., Coinbase), or customer-supplied data, the platform may use an open-source system such as an APACHE® KAFKA® to reliably receive and decouple financial or transaction data from the external heterogeneous sources. For example, external data streams from the heterogeneous sources may be pushed into a streaming platform such as the APACHE® KAFKA®, and the external data streams can be decoupled and stored into the database without losing control of continuity of the external data streams in the streaming platform. The decoupled external data streams may be parsed and stored into the database as a non-relational document database that can provide support for JSON-like storage, or similar document-based non-relational management system e.g., MongoDB, MongoDB Atlas, or the like. Here, the stored transaction data may include a unified internal representation of the parsed financial data from the different external sources.

In one embodiment, the platform may associate one or more atomic primitive operations of an action to a particular stored transaction data based upon the metadata, and other details of the parsed transaction data. For example, a trading action component—BuyOp may be associated by the platform to a particular stored transaction data when corresponding parsed external data (or trading action) shows decrease in a subscriber's dollar account and an increase in number of assets in between states. In another example, a trading action—SellOp may be associated by the platform to another stored transaction data when the corresponding parsed external data (or trading action) includes an increase in the subscriber's dollar account and a decrease in the number of assets during state transition, and so on. In these examples, the trading action may generate the associated atomic primitive operations that can represent financial activity of the subscriber. In another embodiment, the atomic primitive operations need not be initially associated during transaction data loading and the platform may request the trading action to generate the operations based on specified logic. In these embodiments, the stored transaction data may include the ID for the atomic primitive operations, transaction ID, source node ID, destination node ID, and the like.

With the stored transaction data, the platform may generate, for example, a subscriber requested financial report on the subscriber's latest blockchain-based financial transaction(s), such as buying and selling of a particular cryptocurrency (i.e., trading action) over a particular time period. The time period may include a previous hour, day, week, or any other period. In this example, the platform may query and retrieve the stored transaction data that correspond to the financial report to be generated. The retrieved transaction data may include at least one action that involves one or more assets from the blockchain-based transaction.

With the queried transaction data, the platform may then assign a value or price to the queried transaction data and particularly to the one or more assets that are involved in the action. The assigning of value or price may be based upon a price of the asset that participated in the action at the time of the transaction. In one embodiment, the platform may use a consistent and transparent centralized validation table of value to time when pricing or assigning values to the asset based upon the time of the transaction involving the asset. The centralized validation table may store prices of the assets at different time periods, different exchange sources, or a combination thereof, that can be used as a reference for the assigning of values to the asset.

For example, the centralized validation table may include information such as types and sources for the assets, transaction dates, and corresponding prices of the assets at the different transaction dates. Here, the prices of the assets at different transaction dates may utilize the United States dollar (USD) as a base currency. In this example, the centralized validation table may provide a uniform price source for the assigning of values to the queried transaction data.

Following the assigning of values to the queried transaction data, the platform may then generate the atomic primitive operations for the one or more actions in the transaction data. In one embodiment, the platform may use the information recorded in the transaction data as well as additional information such as a locational jurisdiction of the subscriber for tax purposes, to generate preconfigured atomic primitive operations that can be representative of financial activities of actions in the queried transaction data. In this embodiment, the preconfigured atomic primitive operations in the database may include the AdjustOp, DiscardOp, and the like.

With the generated atomic primitive operations for the one or more actions in the transaction data, the platform may match the generated atomic primitive operation with another atomic primitive operation. Without limitation, the platform may use a table of preconfigured pairings as a reference for the matching. For example, the generated atomic primitive operations that can be matched with one another can include the pairings between the generated BuyOp and the generated SellOp; BorrowOp and the PaybackOp; BorrowOp and the SellOp; BuyOp and the PaybackOp; BuyOp and the DiscardOp; and the BorrowOp and the DiscardOp. In this example, the platform allows matches only between “producing” operations (BuyOp and BorrowOp) and “consuming” operations (SellOp, PaybackOp, and DiscardOp). For example, matching a SellOp with a PaybackOp is disallowed. USD operations such as the USDEarnOp and the USDReceiveOp may not be matched as described herein. Further, the AdjustOp, which is a “meta” operation that acts on the BuyOps and the SellOps to adjust cost basis or proceeds may not be matched with another atomic primitive operation.

For example, the associated atomic primitive operations from the queried transaction data may include a BuyOp on account of buying 10 ETH by the subscriber and a SellOp on account of selling 20 ETH by the subscriber within a particular time period. In this example, and based upon preconfigured pairing-referenced as enumerated above, the BuyOp may be matched with the SellOp. This pairing, for example, may be implemented to determine an income value (positive or negative) generated by the trading action operations within the particular time period. Here, a particular action may generate the AdjustOp to adjust the cost basis in the BuyOp or the proceeds in the SellOp. The action may link an AdjustOp to this trading action (to incorporate fees or other adjustments to the cost basis) or can leave the trading action operations unlinked, in which case the platform may again attempt to link the AdjustOp to the BuyOp and/or SellOp at a later stage of a pre-processing pipeline as described herein.

In some embodiments, AdjustOp is used to adjust the cost basis of a BuyOp or the proceeds of a SellOp. Actions may generate AdjustOps at the operations generation stage, and may link them to BuyOps and SellOps, or may leave them unlinked in which case the system may try to link them to BuyOps and SellOps at a later stage of the pre-processing pipeline.

After the matching in the preceding example, the platform may repeat the matching step again using different cost basis methods (e.g. FIFO, LIFO etc.) to determine or aim to determine which method achieves (e.g., within a tolerance) the most favorable cost basis calculation from a tax perspective for the queried transaction data. By determining and implementing the cost basis method that generates a favorable cost basis, the platform may be able to select the cost basis method to be applied to the determined income value to reduce the subscriber's taxable income.

In one embodiment, the value assignment and generation of the atomic primitive operations may be performed prior to receiving of the subscriber request or interaction with the user. In this embodiment, the platform may send notification alerts to the subscriber or user without initial interaction such as requesting for the financial report. Here, the pre-processing of the transaction data may reduce latency for the platform to show reports which the user may have subscribed to receive.

In one or more embodiments, a transaction identifier (ID) may be assigned to the transaction by a host service, for example. The transaction ID permits the host service to associate one or more actions used to carry out the transaction. An asset trade is one example of an action that underlies a financial transaction. An asset trade may involve the buying of an asset by an investor at a market price or other consideration agreed upon by the trading parties. In an example described herein, the asset trade is the purchase of an amount of Bitcoin (BTC) and the transaction ID is a simple alphanumeric ID. In some embodiments, the form of the transaction ID may be associated with assets or trades of a particular type; in others, the transaction ID may be agnostic.

A financial transaction comes with a cost. If a blockchain is invoked, the cost may be the gas incurred to use resources that implement the blockchain. Other costs may be incurred for using an intermediary such as a broker, regulatory surcharges, and the like. The determination of such costs relative to the transaction are actions that can be labeled FeeActions. Fees related to a single transaction may be lumped into one value (fee) or broken out according to the nature or source of the charge. In some embodiments, a FeeAction may generate an operation, such as an AdjustOp, that may be matched to a BuyOp or SellOp for cost basis adjustment.

A transaction can be associated with one or more actions that underly the transaction. For example, an asset trade, a type of trade action (TradeAction) has been mentioned. The TradeAction can be associated with a FeeAction for the same transaction. Generally, actions may be predefined for the platform and, in the case of a DAO (decentralized autonomous organization), proposed and voted on by members before being deployed, in which case the actions become “predefined” at the time of deployment. Predefined actions may thus be called in response to a query for a particular transaction. In some examples, smart contracts may be invoked to call an action or actions as the result of a query input.

When an action is identified to the transaction, one or more operation components of the action (e.g., operations that are associated with the action) are generated. In some embodiments, the host service may receive an event indication from the DAO and, per a smart contract, lookup, program, or other association, generate the operation(s) that carry out the action. Some actions have no associated operations (e.g., a MoveAction such as an account deposit or withdrawal), or do not generate operations under certain conditions (e.g., a MiscAction such as a failed transaction).

The host service may assign values to the operations in the context of the action (e.g., the purchase price of an asset in a BuyOp of a TradeAction, the sale price of an asset in a SellOp of a TradeAction, or a transaction fee in an AdjustOp that may be added to the purchase price to increase the cost basis of the purchased asset or deducted from the sale price of the asset sold). In some instances, the assigned values may be retrieved from a database where they were stored in association with, e.g., the asset purchase contemporaneously with the purchase; in others, they may be introduced contemporaneously with the action.

One or more of the generated operations may then be matched by, e.g., the host service or entity communicating with the host service. There may be various criteria for determining which operations are matched for an action. Generally speaking, operations may be matched for a particular transaction before user interaction (e.g., in the form of requesting a report or entering a transaction), the matching being effected in accordance with executable code that calls or causes the operations to be generated. In this context, the description may refer to an action “generating operations”. In practice, the operations may be created previously and invoked as a result of detecting the action by the host service or identifying the action by its associated entity. For the purposes of this description, it is understood that “generating operations” means that the operations are invoked or called or otherwise caused to execute, as well as being “generated” in a more literal sense.

In some embodiments, the operations may be matched at the time that a report is requested or information related to a transaction or action is needed. For example, operations may be matched in accordance with a smart contract when a taxable (or non-taxable) event occurs. In another example, operations may be matched contemporaneously with a transaction that does not include an action with a deferred operation as described elsewhere herein, in which case a smart contract may input a transaction as an event that triggers operation generation, data retrieval, value assignment, matching, report generation/output, and/or the like.

Sometimes component operations to be matched include an operation that is completed after its matching operation. One example is a TradeAction. Consider a transaction in which a cryptocurrency (“crypto”) such as BTC is purchased. At the time of purchase, a value can be assigned to the BTC purchase and the TradeAction generate a BuyOp to cause entry of the transaction in various databases and ultimately a blockchain in the case of an on-chain transaction. While the details of the purchase may be recorded and its effects on various accounts may be carried out and recorded, the cost basis is not necessarily set. That is, by policy, the cost basis may be recorded as the purchase price of the asset or as the purchase price plus a fee (a single fee or a collective of plural fees) associated with the purchase. On the other hand, by policy, the cost basis may be undetermined until part or all of the asset is sold. In some instances, it may be desirable to change the cost basis at a later time. Thus, in the aforementioned BTC purchase, a smart contract or other technique may cause an entry of the purchase price alone as the cost basis, with some or all of the fee added later to the purchase price when the BTC (or some of the BTC) is sold, thereby determining the cost basis in a manner favorable for the transactor's tax reporting in a particular tax period. In another scenario, it may be more favorable from a tax perspective to increase the cost basis at the time of purchase by the total amount of the fee, perhaps to generate a larger capital loss (or smaller capital gain) for a particular tax period. In a short sale, the fee may be applied to reduce the proceeds of the sale up front in some circumstances.

When there are options for selecting purchases and sales, there can be several ways to match operations for sound tax accounting. Three ways are assigning a specific identification to the transaction, a first-in-first-out method for obtaining and disposing of the same asset (not necessarily a set of transactions for an identical number of the asset), and a last-in-first-out method for obtaining and disposing of the same asset (again, not necessarily a set of transactions for an identical number of the asset). In addition, or in the alternative, a manual override can be effected to assign an identifier manually, i.e., not according to a preset method such as these.

The techniques in the preceding example may be used to generate financial reports for the subscriber, for example expense report, profit report, fees report, holdings report, debt report, and the like. In order to generate the reports the platform may read and process the generated operations, potentially in the context of the actions that contain them. For example a profit report may subtract the proceeds recorded in SellOps from the basis recorded in BuyOps across all actions, whereas a debt report may query only debt actions to tally BorrowOps against PaybackOps contained in them, for example profit and loss. Without limitation, the platform may perform the pre-processing continuously, within a regular predefined interval (e.g., every hour), or upon a detection of a triggering event such as the receiving of the subscriber request.

Some implementations and operations described herein may be ascribed to the use of a server; however, alternative implementations may execute certain operations in conjunction with or wholly within a different element or component of the system(s). In particular, in accordance with at least one embodiment, server functionality may be distributed across multiple computing devices, including devices that do not primarily and/or typically act in the role of servers such as network edge devices. Further, some of the techniques described herein may be implemented in a number of contexts, and several example implementations and context are provided with reference to the figures. The term “techniques,” as used herein, may refer to system(s), method(s), computer-readable instruction(s), module(s), algorithms, hardware logic, and/or operation(s) as permitted by the context described above and throughout the document.

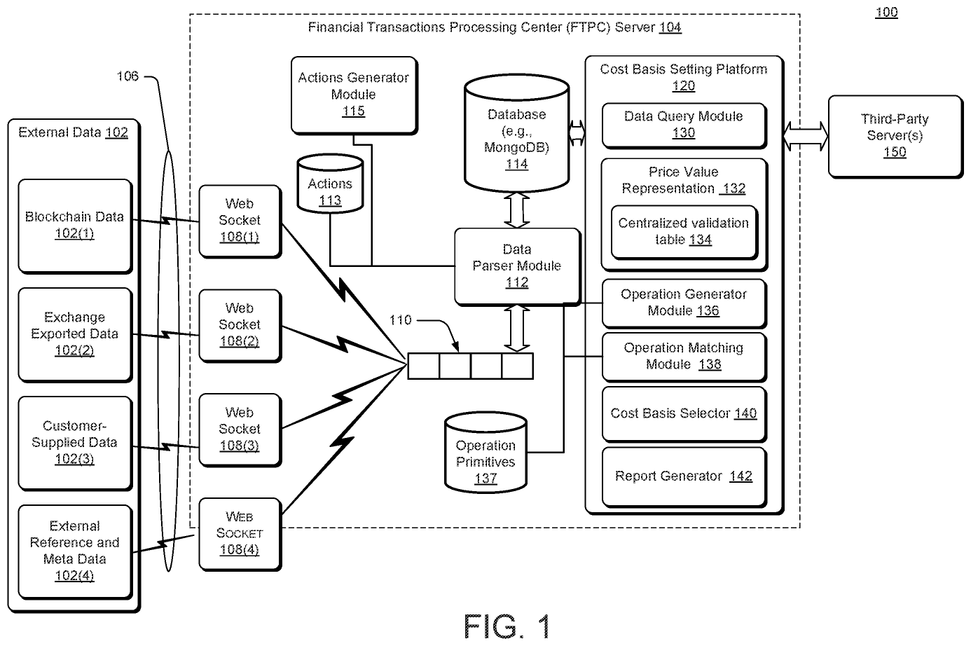

FIG. 1 illustrates a schematic view of an example computing architecture 100 that implements a platform for establishing a cost basis calculation based on atomic primitive operations. In accordance with at least one embodiment, external data including blockchain-based financial transactions may be parsed and stored in a non-relational document database that can provide support for JSON-like storage, or a similar document-based non-relational management system. With the stored transaction data, transaction data involving one or more assets from the blockchain-based financial transaction may be queried and retrieved from the non-relational document database. In one embodiment, one or more atomic primitive operations may be generated from the retrieved transaction data. In this embodiment, the generated atomic primitive operations may be matched and processed to generate, for example, the financial report or financial report notification alert to the subscriber. In some embodiments, the financial report notification alert may be based upon a request received from the subscriber or the financial report that the subscriber subscribed to receive. The financial report or financial report notification alert may include a profit and loss report, expense report, profit report, fees report, holdings report, debt report, and the like.

As shown, the computing architecture 100 may include external data 102 including, without limitation, blockchain data 102(1), exchange exported data 102(2), customer supplied data 102(3), and external reference and metadata 102(4). The external data 102(1)-102(N) may be connected to a financial transaction processing center (FTPC) server 104 through a network 106. The FTPC server 104 may include, for example, a decentralized and distributed platform for software applications that is immutable and supports consensus and transparency. The FTPC server 104 can also be operated by a third party to provide financial reports to subscribers such as individual taxpayers or other entities.

The FTPC server 104 may implement web sockets 108(1)-108(N), a receiving queue 110, a data parser module 112, database 114, and a cost basis setting platform 120 that further includes a data query module 130, a price value representation 132 with a centralized validation table 134, an operation generator module 136, an operation matching module 138, a cost basis selector 140, and a report generator 142. The cost basis setting platform 120 may be communicatively connected to a third-party server(s) 150 that can provide an additional source of external data. Each component or module of the FTPC server 104 can be realized in hardware, software, or a combination thereof. For example, the web-sockets 108(1)-108(4) may be implemented by a software module(s) designed to facilitate communications between the FTPC server 104 and the external data 102.

The external data 102 may include financial transaction data involving assets owned, purchased, sold, traded, received, given, or transacted to and by a subscriber (not shown) on a blockchain-based financial transaction or off a blockchain. The assets may include any other property that is quantifiable and associated with an economic value. In some examples, the assets may include digital assets or cryptocurrency, tokens, NFTs or the like. The external data 102 may include external data that can be stored in the FTPC server 104 and further processed to generate a financial report(s) to a requesting subscriber.

Blockchain data 102(1) (e.g., Bitcoin, Ethereum, etc.) may include blockchain-based financial transaction data where the transaction data can be stored in blocks validated by participating nodes, linked to each other, thereby creating a chain of immutable interconnected data entries. Immutability in blockchain may mean that no information that is included in the data of the blocks can be changed without being detected. The information may be managed by a set of decentralized nodes, removing the need for a central authority to validate the transactions. In some instances, the blockchain data 102(1) may be a distributed ledger of transactions in chronological order, or may be presented in any order that may be suitable for use by a blockchain network. For example, the transactions recorded in the blockchain may include a destination address and a currency amount, such that the blockchain records how much currency is attributable to a specific address. Additional information may also be captured such as a source address, timestamp, and the like.

Exchange exported data 102(2) may include data from cryptocurrency exchange entities where coins such as Bitcoin, Ethereum, Solana, and the like, can be bought, sold, or traded. In one example, the exchange exported data 102(2) may include traded, bought, sold, staked, borrowed, lent, etc. cryptocurrency by the subscriber during a particular time period. In this example, the exchange exported data 102(2) that may be transmitted to the FTPC server 104 can include associated transaction fees and other fees that relate to the buying, selling, or swapping of the cryptocurrency. For clarity, the “Exchange” can be a centralized or decentralized entity and includes digital asset exchanges like Coinbase and Binance, but also decentralized exchanges (like Uniswap) or other entities like custody providers (e.g. BitGo), staking services, “Over the counter” (OTC) exchange providers etc.

Customer supplied data 102(3) may include financial transaction data from direct trading or personal transactions by the subscriber and can be directly transmitted to the FTPC server 104. The customer-supplied data 102(3) may also include financial data such as transaction fees, expenses, and other data that may be used in generating the financial report as described herein. In one example, the customer-supplied data 102(3) may include peer-to-peer (P2P) cryptocurrency trading, transaction fees and expenses associated with the P2P cryptocurrency trading, and the like. Another example of customer supplied data is “meta data” about specific digital asset wallets and exchanges. For example, this can include the “geographical” or “jurisdictional” location of a specific wallet or transaction or notes. Because there are many different ways a digital asset can enter or leave a digital asset wallet, each way may be identified, classified and stored as transaction information on the atomic level in the customer-supplied data to allow, e.g., accurate accounting treatment as described herein.

External reference and metadata 102(4) may include historical transaction or market prices such as prices of the assets at different time periods, different exchange sources, or a combination thereof, that can be used as a reference for the assigning of values to the asset; and other similar information.

The above examples of external data 102 are non-limiting and may include other financial transaction data from other external sources having trading platforms that can be linked to the FTPC server 104. One such example is a trading desk linking its trading platform to the FTPC server 104, allowing trades to be captured in the system as they occur. The transaction data from each of the external data 102 may be received and stored by the FTPC server 104 via the network 106. The stored transaction data may include associated metadata such as, but not limited to, a subscriber ID, source ID, transaction ID, type of cryptocurrency, timestamps for each transaction, subscriber financial account ID, destination node ID, and other similar information. In one embodiment, the external data 102 may be continuously processed to generate output data that can include financial reports or financial report notification alerts that the subscriber subscribed to receive. In other embodiments, the pre-processing of the external data 102 may be triggered by a detection of an event such as receiving of a subscriber request or loading of new data. Alternatively, or additionally, the pre-processing of the external data 102 may be performed at a regular interval such as every minute, hour, etc.

The network 106 may be, without limitation, a local area network (“LAN”), a larger network such as a wide area network (“WAN”), a carrier network, or a collection of networks, such as the Internet. Protocols for network communication, such as TCP/IP, may be used to implement the network 106. The network 106 may provide telecommunication and data communication in accordance with one or more technical standards. While the third-party server(s) 150 are not shown to connect through the network 106, the FTPC server 104 may access the third-party server(s) 150 via the network 106 or other communication mediums.

Each one of the web-sockets 108(1)-108(4) may include an endpoint of a two-way communication link between two programs running on the network 106. The endpoint includes an Internet Protocol (IP) address and a port number that can function as a destination address of the web-socket. Each one of the web-sockets 108(1)-108(4) is bound to the IP address and the port number to enable external entities such as the blockchain data 102(1), exchange exported data 102(2), customer supplied data 102(3), and external reference and metadata 102(4) to communicate with the FTPC server 104. In one example, the web-sockets 108(1)-108(4) may be set up to receive external data streams from the blockchain data 102(1), exchange exported data 102(2), customer-supplied data 102(3), and external reference and metadata 102(4), respectively. The received external data streams may be pushed to the queue 110 before they are decoupled, via the data parser module 112, and stored into the database 114.

In one example, the decoupled external data streams may include the data streams that the database 114 has subscribed to receive via a publish/subscribe mechanism of the queue 110 (e.g., as provided by APACHE® KAFKA®). For example, the decoupled external data streams may include blockchain-based financial transaction data at a particular time period, type of cryptocurrency, subject of the transaction, or a combination thereof, for example. In this example, database 114 may subscribe to receive the external data streams via the queue 110. As described herein, the decoupling of the external data streams may include independently retrieving and processing the data streams without affecting the continuity or configuration of the external data streams that may be continuously received via the queue 110.

In one embodiment, the data parser module 112 may transform the decoupled external data streams to conform with a schema structure (e.g., JSON-like storage) of the database 114. The data parser module 112 may filter log entries, search for data and patterns in files of various data formats, convert log files from one data format to another data format such as the data format that is supported by MongoDB, and the like. In some instances, the data parser module 112 may identify details of the decoupled external data streams and can associate corresponding financial actions to the identified decoupled external data streams from the queue 110. The association may be based upon the details of the decoupled data streams that can include, without limitation, detected changes (deltas) in a subscriber's bank account or accounts managed directly on the blockchain by Decentralized Finance (“DeFi”) protocols, increase or decrease in the number of assets, asset identification, transaction IDs, source node IDs, destination node IDs, timestamps, ID for a type of transaction, identification of parties, and similar information. For example, a trade action may be associated with a parsed transaction data related to a detected decrease in a subscriber's dollar, stable coin, or token asset account and an increase in number of assets in between states. In this example, the state of the asset before and after transition may be used as a reference to generate, e.g., a BuyOp for the parsed transaction data. In another example, the trade action in the parsed transaction data may relate to a detected increase in a subscriber's dollar account and a decrease in number of assets in between states. In this other example, the state of the asset before and after the transition may be used as a reference to generate, e.g., a SellOp for the parsed transaction data.

In some implementations, the data parser module 112 may access the actions storage 113. The actions storage 113 may store data indicating the actions that the data parser module 112 may utilize to describe each identified transaction. The actions storage 113 may store data identifying actions that are received from a user and/or another computing device. For example, the actions storage 113 may store data identifying a trade action, a mint action, a burn action, and/or any other similar action. The data identifying these actions may be received from a user. The actions storage 113 may store data identifying actions that are generated by the actions generator module 115. The actions generator module 115 may be configured to generate actions dynamically. The data parser module 112 may be parsing the data streams in the queue 110, identifying transactions in data streams in the queue 110, and attempting to assign actions to an identified transaction. The data parser module 112 may be unable to assign actions to an identified transaction. This may be because the transaction is a new type of transaction. In this case, the data parser module 112 may request that the actions generator module 115 generate new actions for the new type of transaction. Additionally, or alternatively, the data parser module 112 may assign actions from the actions storage 113 for the new type of transaction.

The database 114 may include a document-based non-relational database management system that can store the parsed transaction data via the data parser module 112. In one embodiment, the database 114 may include a non-relational document database that provides support for JSON-like storage. For example, the non-relational document database may store data objects in collections and documents instead of tables and rows in traditional relational databases. In this example, the collections may include sets of documents, which may be akin to tables in the relational database while the documents can consist of key-value pairs as the basic unit of data. For instance, for a particular transaction data, the database 114 may store the transaction ID which can be an action ID, associated atomic primitive operation ID, source ID, destination ID, subject of transaction ID, type of transaction ID, bank account ID, and the like. In this instance, the associated atomic primitive operation ID may be utilized by the FTPC server 104 as a reference to identify the atomic primitive operations to be generated and matched for purposes of generating the financial report as described herein. The FTPC server 104 may further utilize the associated atomic primitive operation ID to track the requested transaction data that will be processed to generate the financial report. In some instances, the atomic primitive operations need not be associated and the FTPC server 104 may generate the operations based upon specified logic of the queried transaction data.

The cost basis setting platform 120 may include an example application that processes the stored financial data in the database 114 to generate the financial report or financial report notification alert that the subscriber subscribed to receive. In one example, the cost basis setting platform 120 may generate a financial report that can be used to determine a favorable taxable income for the subscriber. In this example, and to generate the financial report, the cost basis setting platform 120 may be configured to perform the querying of stored financial transactions in the database 114 and processing of the queried financial transaction data to generate the content for the financial report.

In one example, the cost basis setting platform 120 may leverage the matching between the generated atomic primitive operations, application of standalone atomic primitive operations such as an application of the AdjustOp to the BuyOps to calculate the cost basis, or a combination thereof, to generate the financial report. In this example, the cost basis setting platform 120 may decompose an action into pre-established atomic primitive operations (e.g., financial primitives) and implement matching of the atomic primitive operations across the appropriate actions for every asset related to the queried transaction data. For example, operations may be generated and matched by the cost basis setting platform 120 irrespective of which report is requested. The platform may match “producing” operations such as BuyOp or BorrowOp with “consuming” operations, such as SellOp, PaybackOp, or DiscardOp. USD operations such as USDEarnOp and USDReceiveOp are not generally appropriate to match. AdjustOp can be considered a “meta” operation (e.g., acting on BuyOps and SellOps) and would generally not be matched. By way of illustration, the generating of the reports such as a sales profit and loss (PnL) report can be facilitated by scanning all the SellOps, checking corresponding matching BuyOps, and subtracting the cost basis (stored in the BuyOps) from the proceeds (stored in the SellOps), for example.

The data query module 130 may include an application that can retrieve the corresponding financial transaction data from the database 114. The querying and retrieval may be performed continuously, over a periodic interval, or upon a triggering event such as the receiving of the subscriber request. The continuous retrieval and pre-processing of the retrieved transaction data may be implemented to send notification alerts without initial or received interactions from the subscriber. In some cases, the retrieved transaction data may be defined by parameters of the notification alerts that the subscriber has subscribed to receive. For example, the parameters can include every transaction action, the transaction actions entered into by the subscriber over a particular period, type or subject of the transaction action, source of external data, or a combination thereof.

With the queried financial transaction data, the price value representation 132 may be configured to assign prices or values to the queried financial transaction data and particularly to the one or more assets that are involved in the action in the queried financial transaction data. In one example, the database 114 may store the timestamps or time of transactions involving the one or more assets in the queried transaction data. In this example, the assigning of values may be based upon the prices of the assets at the time of the transaction such as at the time of buying of the asset, selling of the asset, and the like.

In one embodiment, the price value representation 132 may provide a consistent and transparent centralized validation table of value to time that can be used as a reference when assigning prices to the assets that are involved in the action. The centralized validation table 134 may store key-value pairs of prices for different types of assets at different time periods and US dollar (or other reference fiat currency or token) exchange rate at the different time periods, for example. The stored information in the centralized validation table 134 may be utilized to provide consistent pricing of the assets involved in the action at the time of the transaction. For example, a trade action from the queried transaction data may involve an asset that was sold on Jan. 10, 2022. In this example, the centralized validation table 134 may be used to determine the value of the asset at that time, i.e., on Jan. 10, 2022.

The operation generator module 136 may be configured to generate the atomic primitive operations that can be used to generate the content for the financial reports. In one embodiment, the atomic primitive operations may be generated from the action or actions that are associated with the queried financial transaction data. The generated atomic primitive operations may include the buying of an asset operation (referred to as a BuyOp), selling of the asset (referred to as a SellOp), borrowing of the asset (referred to as a BorrowOp), paying back debt in an account (referred to as a PaybackOp), discarding of the asset as if nothing is received (referred to as a DiscardOp), adjusting of cost basis or sale proceeds (referred to as an AdjustOp), earning or losing an amount (positive or negative) of USD (referred to as USDEarnOp, representing a taxable gain (loss)), and/or receiving USD (referred to as USDReceiveOp, representing a non-taxable receipt of USD). Here, the operation generator module 136 may apply preconfigured rules corresponding to financial semantics or specified logic of the actions associated with the transaction data to identify the atomic primitive operations to be generated. For example, a DebtAction that may represent borrowing by a subscriber may generate a BorrowOp that can be used as a reference to facilitate generation of a debt report. In this example, and in a case where the subscriber executed a short sale, the generated BorrowOp can be matched with the SellOp and this link can facilitate the generation of the PnL report.

The following is an illustrative example of code for processing a TradeAction according to concepts and embodiments disclosed herein:

```
{
  _id: “tx1-01a3df8b8d204fab8a75e19c7733cf20”
    // transaction id assigned by host service //
  actions: [
    // the actions that occurred in this transaction//
    {
      type: “TRADE”,
      subtype: “atomic”,
        // other examples: for a DebtAction, debt/borrow or debt/payback,
        not sure
      what trade/atomic is //
      provider: “coinbase”,
      deltas: {
        USD: “−6000”,
        ETH: “10”
      },
        ops: [
          {
          op_id: “tx1-01a3df8b8d204fab8a75e19c7733cf20-00-00”,
              // derived from the tx_id //
          type: “BUY”,
          dt_op: Date(“2021-01-01T01:00:00.000Z″),
          spec_id_lots : null,
              // pointers to other ops with which the other ops are force-
          matched //
              // spec_id = specific identification table, maps ops to
              other ops
          and asset amounts //
          matches : {
            “tx1-d0185ae8153f4cd4bc329342730445f5-00-00” : {
              // the blockchain or exchange transaction ID for this
            transaction //
              type: “DISCARD”,
                // match to BuyOp //
              dt_op: Date(“2022-01-01T01:00:00.000Z”),
                // for all ops EXCEPT buy/sell //
                // typically = that of the transaction containing the op //
              dt_delivery: Date(“2022-01-01T01:00:00.000Z”),
                // ONLY for buy/sell //
              dt_receipt: Date(“2022-01-01T01:00:00.000Z”),
                // ONLY for buy/sell //
              from_asset: “ETH”,
              from_amount: “0.01”,
              to_asset: “ETH”,
              to_amount: “0”,
              asset: “ETH”
            }
          },
          dt_delivery: Date(“2021-01-01T01:00:00.000Z”),
          dt_receipt: Date(“2021-01-01T01:00:00.000Z”),
          asset: “ETH”,
          asset_amount: “10”,
          unadjusted_usd_amount: “6000”,
              // adjustments (table format) can be entered here as a
          separate parameter //
          dt_possesion: Date(“2021-01-01T01:00:00.000Z”)
              // acquired or borrowed //
        }
      ]
    }
  ],
  chain: “Ethereum”
    // the blockchain the transaction was recorded from; “none” if
    off-chain //
  txid: “0x1000”,
  direction: “outgoing”,
    // the transaction was received; “incoming” means the xaction
    was sent //
  is_virtual: false,
    // virtual transactions are generated automatically to capture continuous
  accrual/payment of interest and similar offsetting //
  notes: “ ”,
    // freeform text //
  dt_tx: Date(“2021-01-01T01:00:00.000Z”),
  dt_created: Date(“2022-06-03T20:47:04.595Z”),
    // the datetime the host service record for the xaction was created //
  ctx: [
    // tracks processing //
    “test”,
    “amend_with_prices”,
    “gen_ops”,
    “handle_fees”,
    “apply_spec_id”,
    “match_ops”
  ],
  groups: [ ],
    // allows joining transactions in groups //
  assets: [
    “ETH”
    “USD”
  ],
  ext_ids: [ ],
    // external IDs, permit interfacing with 3d party systems and dbs //
  prices: {
    USD: {
      coinbase: {
        price: “1”,
        unit: “USD”,
        provider: “coinbase”
        dt: Date(“2021-01-01T01:00:00.000Z”)
      }
    },
    ETH: {
      coinbase: {
        price: 739.725882352941198405460454523563385009765625”,
        unit: “USD”,
        provider: “coinbase”,
        dt: Date(“2021-01-01T01:00:00.000Z”)
      }
    }
  }
}
```

A brief explanation of the fields in this example:
_id: unique tx ID generated and assigned by the host service
actions: the list of actions that occurred as part of the tx
chain: the blockchain the tx was recorded from, “none” for off-chain txs
txid: the blockchain or exchange transaction ID for the tx
direction: “incoming” or “outgoing” (was the transaction sent or received)
is_virtual: True/False. Virtual transactions are txs that are generated automatically by the host service to capture continuous accrual or payment of interest, and similar types of offsetting.
notes: free form text
dt_tx: the datetime of the tx, in UTC
dt_created: the datetime the host service record for the tx was created, in UTC
ctx: tracks the origin and the processing performed on the tx record
groups: allows joining txs in groups
assets: the assets that were involved in the tx
ext_ids: list of external ids relevant for the tx, for example in order to interface with 3rd party systems and databases
prices: asset prices at the time of the tx

### For Actions:

type: the action type (trade, move, debt, fee, etc)
subtype: subtype of the action type (for example debt/borrow vs. debt/payback)
provider: the party facilitating the action (for example “coinbase”). Can be “self”.
deltas: the asset and account balance changes resulting from the action, recorded with arbitrary-precision.
ops: the operations that the action generated to represent the breakdown of its economic activity into financial primitives.
spec_id: specific identification table, mapping operations to other operations and asset amounts.

### For Operations:

op_id: unique operation ID (derived from the tx_id)
type: the operation type (buy, sell, borrow, payback, etc)
dt_op: (for all operations except buy and sell) the effective datetime of the operation (typically the date of the tx containing it)
dt_delivery, dt_receipt: (only for buy and sell operations) constructive delivery and receipt dates, in UTC
spec_id_lots: pointers to other operations which the operation is forced to be matched with (if valid)
asset: asset bought/sold/borrowed etc
asset_amount: amount of asset bought/sold/borrowed etc
unadjusted_usd_amount: USD amount in buys and sells before applying fees (which will increase the cost basis in buys and reduce the proceeds in sales)
adjustments: a table of adjustments to the USD amount
dt_possesion: the datetime in UTC the asset in the operation came into the possession of the host service, if acquired or borrowed by another party.
matches: the operations this operation was matched with (the possible matches are Buy<->Sell, Borrow<->Payback, Borrow<->Sell, Buy<->Payback, Buy<->Discard, Borrow<->Discard).

With the generated one or more atomic primitive operations, the cost basis setting platform 120 may identify the generated atomic primitive operation(s) that can be matched with another atomic primitive operation(s), linked with another operation(s), or a combination thereof. In identifying the matching pairs, for example, the operation matching module 138 may store a table of preconfigured pairs of matching atomic primitive operations such as between the generated BuyOp and the generated SellOp; BorrowOp and the PaybackOp; BorrowOp and the SellOp; BuyOp and the PaybackOp; BuyOp and the DiscardOp; and the associated BorrowOp and the associated DiscardOp. Each of these pairings may be retrieved from the table and used as a reference when identifying the generated atomic primitive operations to be matched or linked with one another.

For example, a SellOp and a BuyOp may be generated from details of a queried trading action. Based on the stored preconfigured pairings, the SellOp and the BuyOp may be matched and stored in the database 114. Further, the AdjustOp may be applied to the BuyOp and the SellOp to adjust cost basis and proceeds, respectively. In this example, the link between the AdjustOp and the BuyOp/SellOp may be stored in the database 114 to allow tracing back of original (or unadjusted cost or proceeds) to justify the adjusted cost basis or proceeds. In one instance, the AdjustOp from a FeeAction (or fee payment action) may be linked to the BuyOp. In this case, the paid fees for the FeeAction may be used as a reference to justify the adjusted cost basis of the BuyOp. The links between the BuyOps and the SellOps (on one side) to the AdjustOps (on the other side) may be many-to-many i.e., a single BuyOp or SellOp can be adjusted multiple times by linking it to multiple AdjustOps, and one AdjustOp can adjust multiple BuyOps and/or SellOps.

For example, a FeeAction representing transaction fees may generate a DiscardOp for every asset paid as fee, tallies up their values and generates an AdjustOp with the combined USD value. The system can then link this AdjustOp with BuyOps and SellOps generated by (for example) a TradeAction in the same transaction. The USD value in the AdjustOp will be used to increase BuyOps cost basis or reduce SellOps proceeds.

The links between the AdjustOps and the BuyOps/SellOps are stored in the DB, allowing to trace back the original and adjusted cost basis/proceeds and to justify these adjustments. For example, if we see a BuyOp with an adjusted cost basis and a link to an AdjustOp, and we see that the linked AdjustOp is inside a FeeAction, we can justify the increase in the BuyOp's cost basis being due to the paid fee.

The operation generator module 136 may store the operation primitives in the operation primitives storage 137. In some implementations, the operation generator module 136 may generate additional operation primitives and store those operation primitives in the operation primitives storage 137. The operation generator module 136 may initiate generation of additional operation primitives in response to a request from the data parser module 112. The data parser module 112 may indicate that the data parser module 112 identified a new transaction. In response to receiving this indication, the operation matching module 138 may determine whether there are operation primitives in the operation primitives storage 137 that may represent the new transaction. The operation matching module 138 may determine that the operation primitives storage 137 includes operation primitives that represent the new transaction. If the operation matching module 138 determines that the operation primitives storage 137 does not include operation primitives that represent the new transaction, then the operation matching module 138 may request that the operation generator module 136 generate additional operation primitives that represent, possibly in part with existing operation primitives, the new transaction. In some implementations, the operation generator module 136 may generate the new operation primitives based on data received from a user and/or a computing device and/or without input.

In the preceding example, the cost basis selector 140 may include an application that facilitates an adjustment in cost basis or proceeds in a trading action and further link the adjustment operation (AdjustOp) to the BuyOp/SellOp components of the trading action. Further, the cost basis selector 140 may facilitate a determination of an optimal adjusted cost basis to utilize that is favorable to the subscriber. For example, the cost basis selector 140 may determine an optimal (or near-optimal) assignment of asset lots for specific identification on every sale operation. In another example, the cost basis selector 140 may determine or calculate the adjusted cost basis for each of the FIFO, LIFO, and other cost basis methods, compare the determined adjusted cost basis from each of these cost basis methods, and select the cost basis method that can generate the optimal adjusted cost basis that is favorable to the subscriber. The optimal adjusted cost basis may include the adjusted cost basis that generates a minimum taxable income.

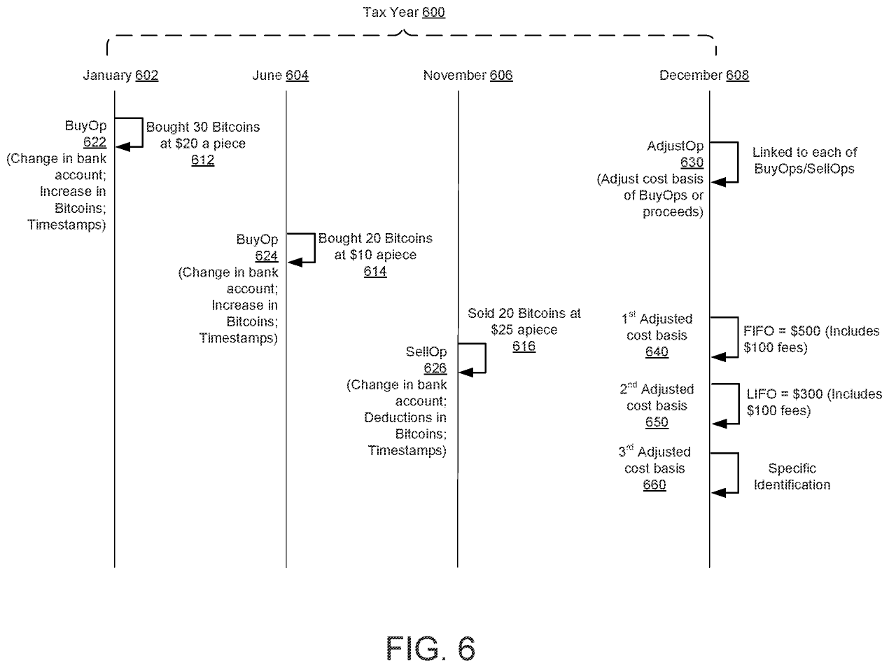

The FIFO cost basis method may include an asset-management and valuation method in which assets produced or acquired first are sold, used, or disposed of first. For tax purposes, the FIFO cost basis method assumes that assets with the oldest costs are included in the income statement's cost of goods sold (COGS). The remaining inventory assets may be matched to the assets that are most recently purchased or produced. Here, the generated atomic primitive operations may be located in a data structure that is defined by the implementation of the FIFO cost basis method. On the other hand, the LIFO cost basis method is an accounting method in which assets purchased or acquired last are disposed of first. The FIFO and LIFO cost basis methods are further illustrated in detail in FIG. 6 below.

While the financial reporting in the preceding example is based upon the matching between the BuyOp and the SellOp, other types of matchings may be applied to generate the financial report. As one, non-limiting example, a pairing between an associated BorrowOp and DiscardOp may be used as a reference to generate accrued interest.

The report generator 142 may generate a financial report or financial report notification alert to the subscriber upon the processing of the transaction data. In one example, the financial report may include a profit and loss statement, fees report, debt report, holdings report, and the like. Entries in the report(s) may be taken from the results of the actions described herein.

The third-party server(s) 150 may provide additional sources of external data that can be retrieved and/or processed as described above. In some cases, the third-party server(s) 150 may provide an additional database similar to the database 114 in the FTPC server 104.

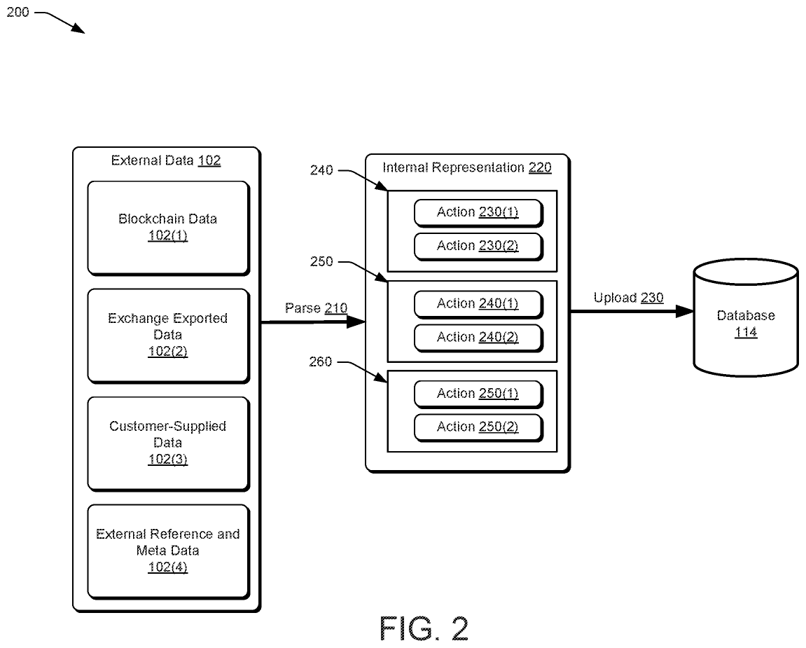

FIG. 2 illustrates a block diagram 200 that shows a receiving and storing of the external data 102 to the database 114. The block diagram 200 may be implemented by the FTPC server 104 in FIG. 1 and particularly, by the data parser module 112.

In one embodiment, the data parser module 112 may parse 210 the external data 102 to generate an internal representation 220 of the received financial data transactions from the different sources or exchanges. Upon parsing of the external data 102, the FTPC server 104 may further upload 230 the derived internal representation 220 to the database 114.

For example, data parser module 112 may transform the blockchain data 102(1), exchange exported data 102(2), customer-supplied data 102(3), and/or external reference and metadata 102(4) to conform with a schema structure (e.g., JSON-like storage) of the database 114. In this example, the data parser module 112 may filter log entries, search for data and patterns in files of various data formats, and/or convert log files from one data format to another data format such as the data format that is supported by MongoDB. In one instance, the internal representation 220 may include a first transaction 240 with associated actions 240(1)(2), a second transaction 250 with associated actions 250(1)(2), and a third transaction 260 with associated actions 260(1)(2). Each of the first transaction 240, second transaction 250, and the third transaction 260 may include metadata such as transaction data ID, timestamps for their respective actions, source ID, destination ID, ID for associated atomic primitive operations, and the like.

In one embodiment, each of the actions in the internal representation 220 may include one of a trading action such as selling and buying assets, a discarding action such as donating the asset, a minting action such as receiving an airdropped asset, a depositing or withdrawing action (to/from account), debt action such as borrowing or paying back an asset, fee action representing fees incurred during a financial activity (e.g., trading fees), asset transfer action representing sending or receiving an asset (such as between a company's own subsidiaries), and the like. Further, each of these actions may be further decomposed into one or more preconfigured atomic primitive operations, which can be representative of the components of the action.

In an embodiment, the uploading of the internal representation 220 may include storing of the transaction data in a particular format such as that of MongoDB which stores data in BSON format. In this embodiment, the database 114 may include a document-based non-relational database management system that can store the uploaded internal representation 220 in the desired particular format. For example, the database 114 may store data objects in collections and documents instead of tables and rows in traditional relational databases. In this example, the collections may include sets of documents, which may be akin to tables in the relational database while the documents can consist of key-value pairs as the basic unit of data. In one instance, and for a particular transaction data, the database 114 may store the transaction ID, associated atomic primitive operation ID, source ID, destination ID, subject of transaction ID, type of transaction ID, bank account ID, geographical identifier ID, and the like.

In some implementations, the data parser module 112 may identify a new transaction and/or determine that a portion of the external data 102 does not correspond to at least one of the known transaction types. If the data parser module 112 determines that the portion of the external data 102 does not correspond to at least one of the known transaction types, then the data parser module 112 may determine a new transaction for that portion of the external data 102 or include the portion of the external data 102 in another identified transaction of the external data 102. The data parser module 112 may take various actions in response to determining a portion of the external data 102 does not correspond to at least one of the known transaction types. A first action may be requesting data from a user that identifies the transaction. This may include outputting the portion of the external data 102 and/or a representation of the portion of the external data 102 to a user and requesting data identifying the type of transaction. The user may provide data identifying the transaction, and the data parser module 112 may proceed with the next steps in analyzing the transaction and/or the external data. A second action may be to analyze the portion of the external data 102 for information related to the type of transaction. The portion of the external data 102 may include metadata that was stored in the blockchain. The metadata may include details related to the type of transaction. These details may be in the form of text describing the use of the cryptocurrency. Using these details, the data parser module 112 may generate a new transaction for the portion of the external data 102. In some instances, the data parser module 112 may determine that the portion of the external data 102 is part of an existing transaction based on analyzing the metadata stored in the blockchain. In this case, the data parser module 112 may group the portion of the external data 102 with the other external data from that transaction.

In instances, where the data parser module 112 receives additional information whether that is from a user, by analyzing the data in the blockchain, and/or another similar technique, the data parser module 112 may update the criteria that it uses to identify transactions in external data. If the data parser module 112 learns of a new transaction, then the data parser module 112 may include data identifying that new transaction in a storage medium that includes other known transactions. If the data parser module 112 learns of additional data that may be included in a known transaction, then the data parser module 112 may include new data identifying that transaction in the storage medium that includes the transaction and other known transactions. The data parser module 112 may access the storage medium that includes the transaction and other known transactions when analyzing future data.

The data parser module 112 may also be configured to identify the one or more actions that are included in each of the new and/or updated transactions. In some instances, the known actions may be sufficient for a new and/or updated transaction. In some instances, the known actions may be insufficient for a new and/or updated transaction. In this case, the data parser module 112 may generate new actions for the new and/or updated transaction.

To identify the actions that correspond to the new or updated transaction, the data parser module 112 may request information from a user. The request may be for data describing the details of the transaction. The request may identify the details of the transaction and may include a representation of the external data. The request may also include any details that the data parser module 112 used to identify the transaction such as additional data included in the blockchain and/or data received from a user. The requested user may provide details related to the transaction, and the data parser module 112 may use that information to match the transaction to one or more actions.

The data parser module 112 may also analyze the portion of the external data that corresponds to the transaction. The data parser module 112 may identify actions within the external data. These actions may correspond to actions that the data parser module 112 previously assigned to other transactions. The data parser module 112 may identify similar types of cryptocurrency movements in the portion of the external data compared to the type of external data that corresponds to known actions. In this case, the data parser module 112 may determine that an action likely corresponds to a transaction based on similar between the underlying external data with known actions.

In some implementations, the data parser module 112 may use a model trained using machine learning. The models may be configured to receive the portion of the external data and output one or more actions that correspond to the transaction of the portion of the external data. The models may be configured to access the known actions and select the likely actions that correspond to the received portion of the external data. In some implementations, the models may not be able to identify a new type of action. In some implementations, the models may be able to output data indicating that none of the known actions correspond to the receive portion of the external data. In some implementations, the models may be able to output data indicating that one or more actions correspond to some of the received portion of the external data and data indicating that additional actions are needed to fully describe the transaction.

The models may be trained using labeled historical data that includes labels that identify the actions for transactions and the corresponding external data. The models may be trained using machine learning. The resulting models may be configured to receive the external data for a transaction and output data identifying the one or more actions that correspond to the external data. In some implementations, the models may be updated using additional historical data as additional actions are added and/or additional external data and actions groups are identified and confirmed. This way, the accuracy of the model may continuously improve as additional external data is analyzed and actions are identified and confirmed.

In some implementations, the models may be configured to output confidence scores that indicate a likelihood that the identified actions correspond to the external data of the transaction. For example, the models may output a confidence score of 0.9 that indicates that the external data of the transaction includes a trade action. The models may output a confidence score of 0.7 indicating that the external data of the transaction includes a burn action. The models may output a confidence score of 0.1 indicating that the external data includes a move action.

In some implementations, the models may be configured to output a confidence score for each action. This may be an appropriate technique when there are limited number of actions for the data parser module 112 to select from. For each action, a corresponding model for that action may receive the external data of the transaction and output a confidence score indicating the likelihood that the corresponding action is part of the transaction. The data parser module 112 may select the actions with confidence scores that are above a threshold as the actions for the transaction of the external data. The training data for these models may be a portion of the overall historical data. For example, the training data for the burn action may include previous external data for a transaction and a flag indicating whether the burn action was part of that transaction. The model may be trained using machine learning and that training data. The resulting model for the burn action may be configured to receive external data for a transaction and output a confidence score that the transaction includes the burn action.

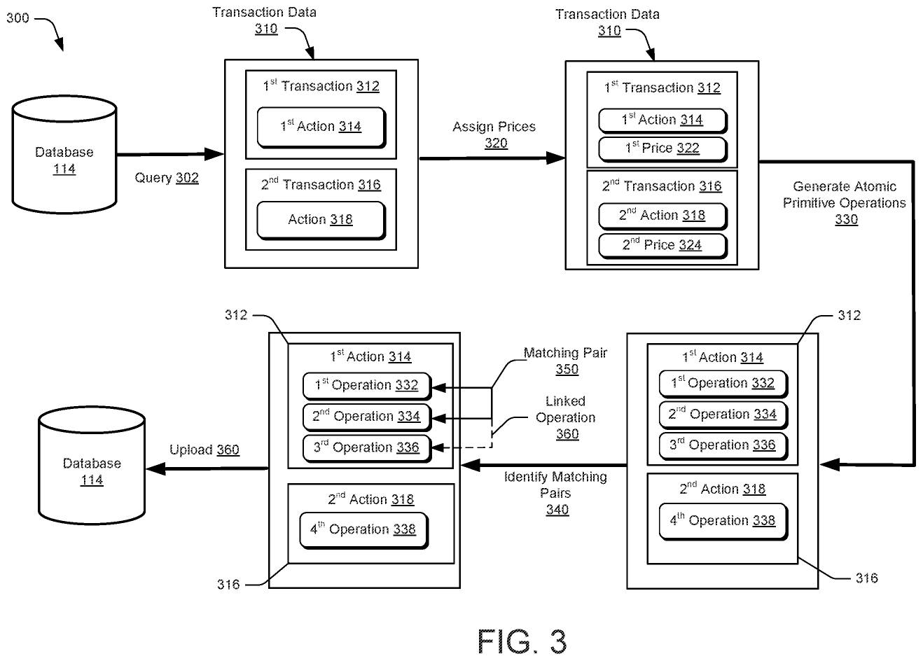

FIG. 3 illustrates a block diagram 300 that shows an example implementation for pre-processing transaction data to facilitate generation of a report. In one embodiment, the pre-processing of the transaction data may be made in multiple passes to construct an accurate model of a financial state of the subscriber at different periods. Here, the atomic primitive operations may be generated and matched regardless of type of report to be requested or generated for the subscriber. In another embodiment, the pre-processing of the transaction data may be triggered by an event, such as receiving of a subscriber request for a particular report. For purposes of illustration, the generation of the report in the discussion below may be in response to a subscriber request for a calculation of the taxable income over a particular action such as a trading action.

In one embodiment, the FTPC server 104 may perform a query 302 on the database 114 to retrieve transaction data 310, which includes a first transaction 312, a first action 314, a second transaction 316, and a second action 318. For example, the first action 314 and the second action 318 may include a trading action and a burn action, respectively. The burn action may include disposing of the asset without consideration e.g., donation. In this example, the first transaction 312 and the second transaction 316 may include metadata and other information of the first action 314 and the second action 318, respectively.

The FTPC server 104 may then assign prices 320 to the first action 314 and the second action 318. Particularly, prices or values are assigned over the assets that are involved in the first action 314 and the second action 318. Here, a first price 322 may include the assigned value of the involved assets in the first action 314 at the time of the corresponding transaction while a second price 324 may include the assigned value of the involved assets in the second action 318 at the time of the corresponding transaction.

With the assigned prices to each asset in the transaction data 310, the FTPC server 104 may generate atomic primitive operations 330 from the corresponding actions in the retrieved transaction data 310. In one embodiment, the generated atomic primitive operations may be taken from the associated atomic primitive operations in the queried transaction data, referenced from stored preconfigured atomic primitive operations such as an adjusting operation (AdjustOp), or a combination thereof. For example, the first action 314 may be associated with a generated first atomic primitive operation 332 (BuyOp), a second atomic primitive operation 334 (SellOp), and a third atomic primitive operation 336 (AdjustOp) while the second action 318 can be associated with a generated fourth atomic primitive operation 338 (DiscardOp). In this example, the first atomic primitive operation 332 (BuyOp), the second atomic primitive operation 334 (SellOp), and the third atomic primitive operation 336 (AdjustOp) may be among the atomic primitive operations that are generated to effect the first action 314 on the queried transaction data 310 while the generated fourth atomic primitive operation 338 (DiscardOp) can be generated to effect the second action 318. In some embodiments, the first atomic primitive operation 332 (BuyOp) and the second atomic primitive operation 334 (SellOp) may be referenced from the atomic primitive operations that are associated from the queried transaction data 310 while the third atomic primitive operation 336 (AdjustUp) and the fourth atomic primitive operations 338 (DiscardOp) can be referenced from the stored preconfigured set of atomic primitive operations.

In one embodiment, the FTPC server 104 may use the table of preconfigure matching in the operation matching module 138 to identify matching pairs 340 among the generated atomic primitive operations in the first action 314, second action 318, or a combination thereof. For example, to calculate the taxable net income for the trading action, a matching pair 350 is representative of the matching between the first atomic primitive operation 332 (BuyOp) and the second atomic primitive operation 334 (SellOp) to generate an income value. In this example, a linked operation 360 may indicate the linking of the third atomic primitive operation 336 (AdjustOp) to adjust the cost basis and the proceeds for first atomic primitive operation 332 (BuyOp) and the second atomic primitive operation 334 (SellOp), respectively. With this adjustment, the linked operation 360 may facilitate the calculation of the taxable net income for the trading action (first action 314).

In one example, the location of the first atomic primitive operation 332 (BuyOp) and the second atomic primitive operation 334 (SellOp) in the data structure may be determined in accordance with the cost basis method (e.g., FIFO) that is currently being applied to determine the taxable income. In some cases, a specific identification method may be used to identify the assets and/or operations to be used in calculating the taxable income. For example, the specific identification method may be used to find an optimal or near optimal assignment of asset lots on every sale.

With the calculated taxable income in the preceding example, the FTPC 104 may upload 360 the results of the matching operations to the database 114. For example, the results may include the calculated taxable income for the first action 314 (trade action) and the amount and value of the lost asset in the second action 318 (burn action). In this example, the results may be included in the content of the financial report to be sent to the subscriber.

In some implementations, during or around the generation of the atomic primitive operations 330, the FTPC 104 may determine that the action is an action that does not have a one or more operation primitives into which the action is decomposable. This may occur because the action is a new action that the FTPC 104 generated because a transaction could not be divided into any of the known actions. This may occur because of new types of activity involving cryptocurrency, new types of cryptocurrency, new uses involving blockchain, and/or any other similar reason.

When the FTPC 104 attempts to decompose an action into its one or more operation primitives, the FTPC 104 may be unable to do so. This may be because the FTPC 104 attempts to decompose an action that the FTPC 104 does not recognize, has not decomposed previously, is unable to access data indicating how to decompose, and/or any other similar reason. To decompose one of these actions, the FTPC 104 may take similar steps used to identify the actions of a transaction. A first process may involve requesting decomposition information from a user and/or a computing device. The FTPC 104 may provide data identifying the action, the underlying external data, any additional blockchain data, and/or any other similar information along with a request to identify the operation primitives for the action. The request may also identify the operation primitives that the FTPC 104 uses to decompose actions. The FTPC 104 may perform this process dynamically during analysis of the external data. Additionally, or alternatively, the FTPC 104 may process the known actions of a transaction and wait to process unknown actions until the FTPC 104 receives a response to the request.

A second process may involve comparing the underlying external data to external data of known transactions that decompose into known operation primitives. The FTPC 104 may determine a similarity between the underlying external data and external data of known transactions. The FTPC 104 may identify common characteristics between the data. Some of the characteristics may include the parties involved in the transaction, amounts of cryptocurrency involved in the transaction, dates and times of the transaction, and/or any other similar characteristic. The FTPC 104 may determine a similarity score based on this analysis that represents a similarity between the underlying external data and the external data of known transactions. The FTPC 104 may select the transaction with the external data with the highest similarity score. The FTPC 104 may decompose the unknown transaction into the same operation primitives as the known transaction with the highest similarity score.

A third process may involve using machine learning to train various models that are configured to output data indicating into which operation primitives a transaction should be decomposed. The models may be trained using historical data. The historical data may include external data and the corresponding transaction. The historical data may also include labels that indicate the operation primitives into which the transaction was decomposed.

The models may be trained in various manners. A first training technique may involve focusing on a single operation primitive. The historical data may be grouped into transactions that decompose into the operation primitive and transactions that do not decompose into the operation primitive. The historical data also include the underlying external data. The models are trained using this grouped historical data. The models are configured to receive a transaction and the underlying historical data, and there is a model for each operation primitive. Each model is configured to output a confidence score that the corresponding operation primitive. The confidence score indicates a likelihood that the operation primitive is one of the operation primitives into which the transaction is decomposed. The FTPC 104 may provide the transaction and the underlying historical data to each model for each operation primitive. The FTPC 104 may then select the operation primitives as the operation primitives into which the transaction is decomposed based on the confidence scores. The FTPC 104 may use a confidence threshold such that the confidence scores above the threshold and those corresponding operation primitives are the operation primitives into which the transaction is decomposed. In some implementations, the confidence threshold may vary. For example, the confidence threshold may be based on a requested threshold from a user.

A second training technique may involve training a single model using the historical data. The historical data may be grouped into transactions and the corresponding external data. Each transaction may include labels that indicate the operation primitives into which the transaction is decomposed. The FTPC 104 may train the model using this historical data. The resulting model may be configured to receive a transaction and the underlying historical data and output data indicating the operation primitives into which the transaction is likely decomposed.

In some implementations, the FTPC 104 may receive additional historical data that indicates transactions and operation primitives. The FTPC 104 may retrain the models using this additional historical data. The additional historical data may be based on transactions processed using the models. In this case, the labels for the operation primitives may be confirmed by a user. By retraining the models, the FTPC 104 can continuously improve the models.

In some implementations, the FTPC 104 may generate a new operation primitive. The FTPC 104 may generate a new operation primitive because the current operation primitives are insufficient for a transaction. The FTPC 104 may recognize this condition if the multiple model technique returns no confidence scores that are above a threshold and/or the single model technique returns no operation primitives. In either case, the FTPC 104 may request input from a user and/or computing device to provide an additional operation primitive. When the FTPC 104 receives the operation primitive and data identifying the corresponding transaction and external data, the FTPC 104 may update the models so that the models may be configured to determine when a transaction should likely be decomposed into the new operation primitive.

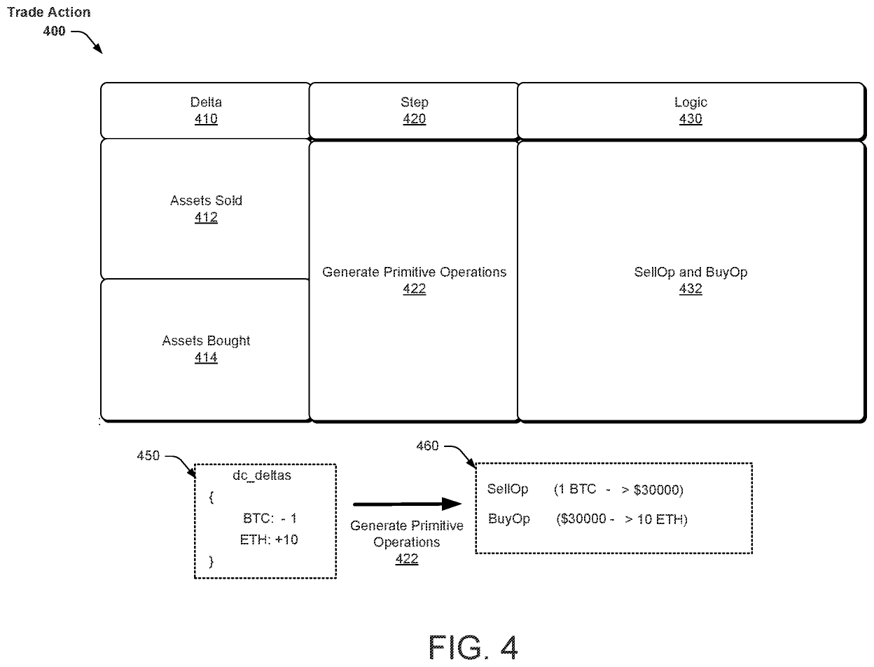

FIG. 4 illustrates a block diagram of an example trade action 400 that includes selling and buying of assets over a particular time period. As shown, the trade action 400 may include a delta 410 that represents changes in assets sold 412 and assets bought 414, a step 420, and a logic 430. The step 420 may represent the pre-processing from the storing of the transaction data to the matching process to generate the financial report as described in FIG. 3 above. In order to generate the atomic primitive operations, the FTPC server 104 may make multiple passes over the same transactions in order to construct an accurate model of the financial state of the subscriber at different points in time.

In one example, the trading action 400 may include selling 1 Bitcoin for $30,000 and buying 10 ETH for $30,000 as shown in representative block 450. Here, the step 420 for the trade action 400 may generate primitive operations 422 that can include BuyOps and SellOps, which are represented by block 432. These atomic primitive operations may be derived from the details of the assets sold 412 and the assets bought 414. In this example, the trade action 400 may generate the SellOp and BuyOp as shown in representative block 460. The generated atomic primitive operations in the representative block 460 may be combined (i.e., selling price minus buying price) to generate a gross income, for example. In this example, another atomic primitive operation such as the AdjustOp may be generated and linked to adjust the cost basis and the proceeds for the BuyOp and the SellOp, respectively, in the trade action 400.

The trade action 400 is for illustration purposes only and other, different actions as described herein may involve corresponding changes in the delta 410 and generated primitive operations 422.

For example, a mint action (not shown) may correspond to an increase in an asset's balance indicated by a positive delta 410. The positive changes may represent earnings via, e.g., mining, validator income, airdrops, or yield generation. In this example, the generated atomic primitive operations may include USDEarnOp and/or BuyOp (e.g., with a pre-adjusted cost basis of $0).

For another example, a burn action (not shown) may correspond to a decrease in an asset's balance indicated by a negative delta 410. The negative changes may represent irrevocable loss of an asset. In this example, the generated atomic primitive operations may include SellOp with zero proceeds or USDEarnOp, which can be an atomic primitive operation indicating a gain or loss of USD and should be treated as a tax event).

For example, the burn action/discard (not shown) may correspond to a decrease in an assets' balance indicated by a negative delta 410. The negative changes may represent the disposition of the asset without consideration. In this example, the generated atomic primitive operations may include DiscardOp.

For example, a fee action (not shown) may correspond to a decrease in asset balances indicated by negative deltas 410. The negative changes may represent payment of a transaction fee. In this example, the generated atomic primitive operations may include DiscardOp and AdjustOP, and so on.

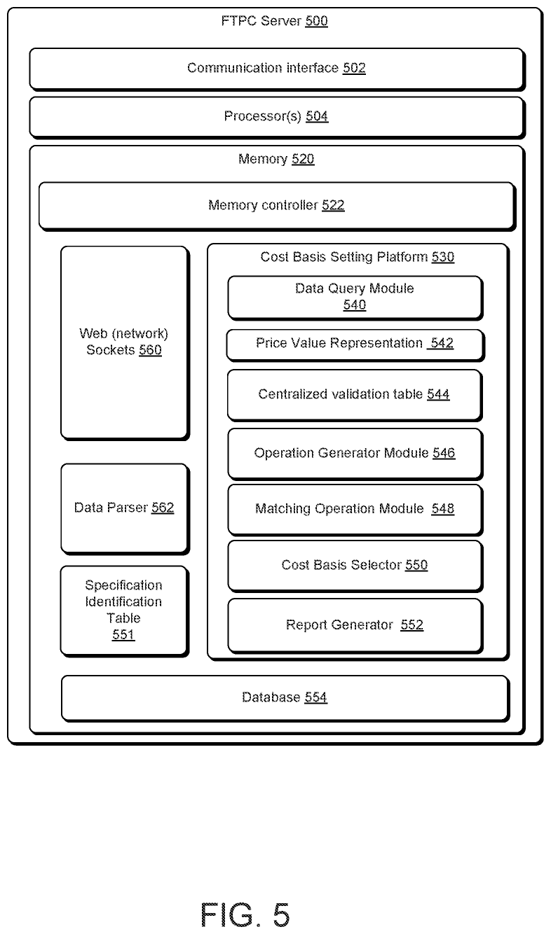

FIG. 5 is a block diagram of an example FTPC server 500 that implements the improving of the cost basis calculation based on atomic primitive operations. The FTPC server 500, which may be similar to the FTPC server 104 of FIG. 1, may include a computer system that receives external data, processes the received external data, and generates a financial report, financial report notification alert, or key indicator (like an airdrop into a wallet) notification alert to the subscriber.

The FTPC server 500 may include a communication interface 502 that facilitates communication with the external data 102. Communication between the FTPC server 500 and other electronic devices may utilize any suitable sort of communication protocol for sending and receiving data and/or voice communications.

The FTPC server 500 may further include a processor 504 having electronic circuitry that executes instruction code segments by performing basic arithmetic, logical, control, memory, and input/output (I/O) operations specified by the instruction code. The processor 504 can be a product that is commercially available through companies such as Intel® or AMD®, or it can be customized to work with and control a particular system. The processor 504 may be coupled to other hardware components used to carry out device operations. The other hardware components may include one or more user interface hardware components not shown individually—such as a keyboard, a mouse, a display, a microphone, a camera, and/or the like—that support user interaction with the FTPC server 500.

The FTPC server 500 also may include memory 520 that stores data, executable instructions, modules, components, data structures, etc. The memory 520 may be implemented using computer-readable media. Computer-readable media includes, at least, two types of computer-readable media, namely computer-readable storage media and communications media. Computer-readable storage media includes, but is not limited to, Random Access Memory (RAM), Dynamic Random Access Memory (DRAM), Read-Only Memory (ROM), Electrically Erasable Programmable Read-Only Memory (EEPROM), flash memory or other memory technology, Compact Disc—Read-Only Memory (CD-ROM), digital versatile disks (DVD), high-definition multimedia/data storage disks, or other optical storage, magnetic cassettes, magnetic tape, magnetic disk storage or other magnetic storage devices, or any other non-transmission medium that can be used to store information for access by a computing device. As defined herein, computer-readable storage media do not consist of and are not formed exclusively by modulated data signals, such as a carrier wave. In contrast, communication media may embody computer-readable instructions, data structures, program modules, or other data in a modulated data signal, such as a carrier wave, or other transmission mechanisms.

A memory controller 522 may be stored in memory 520 of the FTPC server 500. The memory controller 522 may include hardware, software, or a combination thereof, that enables the memory 520 to interact with the communication interface 502, processor 504, and other components of the FTPC server 500. For example, the memory controller 522 may receive external data streams from the communication interface 502 and facilitate storing of the received external data streams in memory 520. In another example, the memory controller 522 may retrieve data streams from memory 520 and the retrieved data streams can be processed in the processor 504.

The memory 520 may include a cost basis setting platform 530 that, when executed, implements the optimization of the cost basis calculation based on atomic primitive operations. As shown, the cost basis setting platform 530 may further include a data query module 540, a price value representation 542 module, with a centralized validation table 544, an operation generator module 546, a matching operation module 548, a cost basis selector 550, a specific identification table 551, and a report generator 552 that may respectively correspond to the cost basis setting platform 120, data query module 130, price value representation 132, centralized validation table 134, operation generator module 136, matching operation module 138, cost basis selector 140, and the report generator 142 of FIG. 1.

The memory 520 may further store and/or implement, at least in part, web-sockets 560, a data parser 562, and a database 570 that may respectively correspond to the web sockets 108, data parser module 112, and the database 114 of FIG. 1. In one example, each component of the memory 520 can be realized in hardware, software, or a combination thereof.

The cost basis selector 550 may select a cost basis method on the basis of comparing the results of applying different methods for determining the cost basis associated with a transaction. For example, and without limitation, the cost basis selector may comprise computer-readable instructions that, if executed by the processor(s) 504, cause the processors to perform one or more calculations which can be compared to determine the cost basis method that is most favorable to the entity purchasing or selling an asset as the case may be. In some examples, calculations are made using more than one cost basis, such as FIFO or LIFO (that is, determining which asset transaction is first (or last) regarding a specific asset, so as to match the same with the first such asset bought/sold by the entity), or by assigning a specific identifier to the first transaction such that a subsequent transaction of the same asset can be matched to the asset so identified. To perform a calculation based on this specific identification method, the processor(s) 504 may refer to the specific identification table 551 for a table that associates specific identifiers with corresponding assets/transactions involving the corresponding assets. The specific identifiers may be assigned by the host service that performs the calculation or by another party from which the host service is able to obtain the specific identification. In some embodiments, the cost basis method may be decided by manually determining which transactions (e.g., buy and sell) to match.

The web-sockets 544 may be implemented by a software module designed to establish communications with the external data 102. In one example, each of the web-sockets 544 is bound to the IP address and the port number to communicate with the corresponding external data source.

In one example, the data parser 562 may include an application programming interface (API) to establish a connection with the event streaming platform. The cost basis setting platform 530 of the FTPC server 500 may subscribe to blockchain data in the event streaming platform and utilize the data parser 562 to facilitate the storing of the blockchain data to the database 554. In this example, the blockchain data may be stored as a non-relational document database that can provide support for JSON-like storage, or similar document-based non-relational management system.

The FTPC server 500 may use the communication interface 502 to transmit a financial report notification alert or receive a subscriber request. Here, the cost basis setting platform 530 may use the data query module 540 to query the transaction data when new external data is stored, continuously to generate the financial report notification alert to the subscriber, or upon receiving of a subscriber request. Upon retrieving of the transaction data, the cost basis setting platform 530 may utilize the price value representation 542 to assign price or pecuniary values to the assets that are involved in the action.

Similar to the discussion in FIGS. 1 and 3 above, the cost basis setting platform 530 may then use the operation generator module 546 to generate the atomic primitive operations, match the generated atomic primitive operations, and use at least the matched atomic primitive operations to generate the content for the financial report.

FIG. 6 is a swimlane diagram illustrating an example cost basis calculation over financial transactions (or trading actions) incurred by a subscriber in a tax year. In the example shown, a tax year 600 is a calendar year during which corresponding financial transactions were incurred by the subscriber. First, in January 602, the subscriber bought 30 Bitcoins at $20 apiece 612. In June 604, the subscriber bought 20 Bitcoins at $10 apiece 614. Then, in November 606, the subscriber sold 20 Bitcoins at $25 apiece 616. As illustrated, the financial transactions over January 602, June 604, and November 606 may correspond to the atomic primitive operations BuyOp 622, BuyOp 624, and SellOp 626, respectively. An AdjustOp 630 may be applied to each of these atomic primitive operations BuyOp 622, BuyOp 624, and SellOp 626 to adjust the cost basis for BuyOp and proceeds for the SellOp (e.g., to account for trading fees). Thereafter, an adjusted cost basis that may generate a minimum taxable income can be selected for income tax filing, for example.

In one example, the trading action and particularly, the trading action component—BuyOp 622 may be based upon changes in bank account, increase in number of Bitcoins, timestamps, etc. in the subscriber's account. Similarly, the trading action components—BuyOp 624 and the SellOp 626 may be based upon the details of the financial transaction data in between nodes in the protocol or workflow. The details may include changes in the assets sold or assets bought as described above.

In one embodiment, the requested financial report may include a favorable calculation of the subscriber's taxable income over the selling of the 20 Bitcoins in November 606. In this embodiment, the FTPC server 500 may link the AdjustOp 630 to each of the trading components—BuyOp 622, BuyOp 624, and SellOp 626 to adjust the cost basis for the BuyOp 622, BuyOp 624 and further adjust the proceeds for the SellOp 626. The linked AdjustOp 630 may belong, for example, to a particular action such as FeeAction that corresponds to calculation of transaction fees. With the adjusted cost basis and proceeds, the FTPC server 500 may then generate a first adjusted cost basis 640 based on a FIFO cost basis method, a second adjusted cost basis 650 based on a LIFO cost basis method, and/or a third adjusted cost basis 660 based upon specific identification. The specific identification may include preconfigured selection of an optimal or near-optimal assignment of asset location for every SellOp, for example.

Assuming that the fees associated with the BuyOp 624 and the SellOp 626 are the same (e.g., $100 amount of fees), the first adjusted cost basis 640 based on the FIFO cost basis method may be $500, which is derived from the cost of the 30 Bitcoins that were purchased on January 602 at $20 apiece plus the $100 fees (note that of the 30 Bitcoins purchased only 20 were sold, hence 20*$20+$100=$500). For the LIFO cost basis method, the second adjusted cost basis 650 may be $300 because the 20 Bitcoins were purchased on June 604 at $10 apiece and $100 fees are added to this purchase. Here, the FTPC server 104 may use the corresponding generated atomic primitive operations when calculating the first adjusted cost basis 640 and the second adjusted cost basis 650. For example, for the FIFO cost basis method, the FTPC server 104 may use the BuyOp 622 to be matched with the SellOp 626. For the LIFO cost basis method, the FTPC server 104 may use the BuyOp 624 to be matched with the SellOp 626.

Assuming that the cost basis generated by the FIFO cost basis method 640 is greater than the adjusted cost basis value that is generated by the use of the LIFO cost basis method 650 i.e., $500, then the FTPC server 500 may utilize the cost value of $500 as the cost basis for the sale 616 for the tax year 600 and thus, possibly reduce the tax liability of the subscriber.

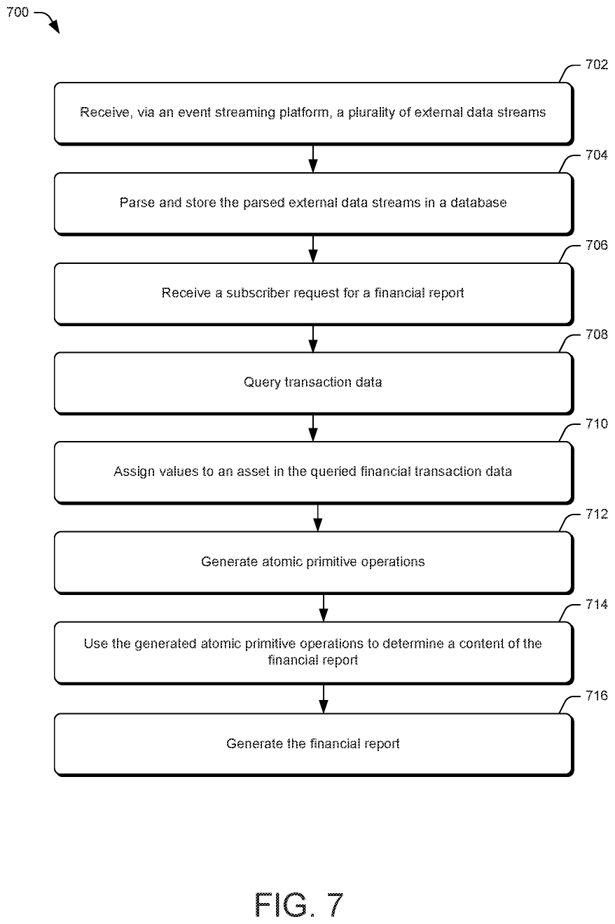

FIG. 7 is a flow diagram 700 that depicts an example process for at least one aspect of the techniques for implementing the platform for improving a cost basis calculation based on atomic primitive operations. In the following discussion of FIG. 7, continuing reference is made to the elements and reference numerals shown in and described with respect to the FTPC server of FIGS. 1 and 5. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 702, the FTPC server 500 may receive a plurality of external data streams from the external data 102. In one example, the queue 110 includes an event streaming platform that receives packets of external data streams encoded in JSON, XML or other structured data modeling language. The external data streams, for example, may include blockchain data 102(1), exchange exported data 102(2), customer supplied data 102(3), and/or external reference and metadata 102(4).

At block 704, the FTPC server 500 may parse and store the parsed external data streams in the database. For example, the data parser module 112 may transform the decoupled external data streams to conform with a schema structure of the database 554.

At block 706, the FTPC server 500 may receive a subscriber request for a financial report. In one example, the parameters in the subscriber request may define the extent of the financial transactions to be processed. The parameters may include, without limitation, the particular time period, type of transaction, subject of transaction, assets involved, or a combination thereof.

In an embodiment, the FTPC server 500 may continuously process the received transaction data. In a case where a particular transaction is missing data, then the FTPC server 500 may use placeholders for additional data that can be requested from the subscriber. In another embodiment, the FTPC server 500 may process the received transaction data periodically. For example, the FTPC server 500 may perform the pre-processing and the generating of the report every one hour, two hours, or any other period.

At block 708, the FTPC server 500, via the data query module 540, may query and retrieve transaction data. In one embodiment, the FTPC server 500 may continuously query and retrieve the transaction data for processing. In a case where a particular transaction data is missing data, then the FTPC server 500 may use placeholders for additional data that can be requested from the subscriber. In another embodiment, the FTPC server 500 may query and retrieve the transaction data that correspond to the financial report notification alert to be forwarded to the subscriber. Here, the retrieved transaction data may include the actions that correspond to financial report notification alert to be transmitted to the subscriber. In various embodiments, the FTPC server 500 may query and retrieve the transaction data for processing based upon parameters of a received subscriber request. For example, the parameters may include, without limitation, the particular time period, type of transaction, subject of transaction, or a combination thereof. In this example, the receiving of the subscriber request may trigger the querying and retrieving of the transaction data.

At block 710, the FTPC server 500, via the price value representation 542, may assign price values to the queried financial transaction data and particularly to the one or more assets that are involved in the action or blockchain-based financial transaction.

At block 712, the FTPC server 500 may generate atomic primitive operations. In one example, the FTPC server 500 may generate the atomic primitive operations that can represent financial activity in the action based on the action's specified logic. In this example, the FTPC server 500 may store and associate the generated atomic primitive operations to the action.

At block 714, the FTPC server 500 may use the generated atomic primitive operations. For example, a matched pair of generated atomic primitive operations may be used to generate a gross income for a particular trading action.

At block 716, the FTPC server 500 may generate the financial report.

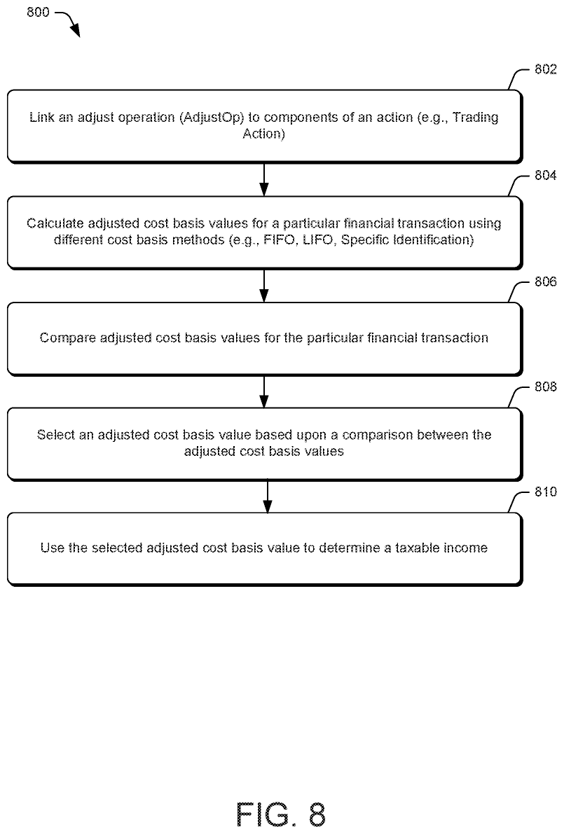

FIG. 8 is a flow diagram 800 that depicts an example procedure for at least one aspect of the techniques for selecting the adjusted cost basis value that can be used to determine, for example, a capital gain resulting from a transaction. In the following discussion of FIG. 8, continuing reference is made to the elements and reference numerals shown in and described with respect to the FTPC server of FIGS. 1 and 5. Further, certain operations may be ascribed to particular system elements shown in previous figures. However, alternative implementations may execute certain operations in conjunction with or wholly within a different element or component of the system(s). Furthermore, to the extent that certain operations are described in a particular order, it is noted that some operations may be implemented in a different order to produce similar results.

At block 802, the FTPC server 500 may link an AdjustOp to components of an action. For example, the action is a trading action having BuyOp and SellOp components. In this example, the links between the BuyOps/SellOps (on one side) to the AdjustOps (on the other side) are many-to-many. A particular BuyOp or SellOp may be adjusted multiple times by linking the BuyOp or SellOp to multiple AdjustOps. In some cases, a single AdjustOp may adjust multiple BuyOps and/or SellOps.

At block 804, the FTPC server 500 may calculate adjusted cost basis values for a particular financial transaction using different cost basis methods. For example, the subscriber purchased 30 Bitcoins for $20 each plus $100 total fees, then later purchased 20 additional Bitcoins for $10 each plus $100 total fees. Assuming that the subscriber sold 20 Bitcoins at $25 each, then the calculated adjusted cost basis values for this particular transaction may be selected via one of the cost basis methods (e.g., FIFO, LIFO, or specific identification).

For example, using the FIFO cost basis method, the adjusted cost basis value for the sold 20 Bitcoins in the above example may include the amount of $20 per Bitcoin plus the $100 total fees for a total adjusted cost basis value of $500. Using the LIFO cost basis method, the total adjusted cost basis value for the sold 20 Bitcoins in the above example may include the amount of $10 per Bitcoin plus the $100 total fees for the total adjusted cost basis value of $300. A specific identification may be further utilized to select the location of the asset that can be associated with the adjusted cost value.

At block 806, the FTPC server 500 may compare the adjusted cost basis values between the different cost basis methods. In the preceding example, and assuming that the specific identification may generate an adjusted cost basis value that is lesser than the FIFO cost basis method, then the FIFO cost basis method may be utilized because of the higher amount ($500) of adjusted cost basis value versus the LIFO cost basis method ($300).

At block 808, the FTPC server 500 may select the adjusted cost basis value based upon the comparison between the adjusted cost basis values from the different cost basis methods.

At block 810, the FTPC server 500 may use the selected adjusted cost basis value on a gross income. The gross income for the particular transaction may be taken from the sale proceeds of an asset minus the adjusted cost basis of its acquisition.

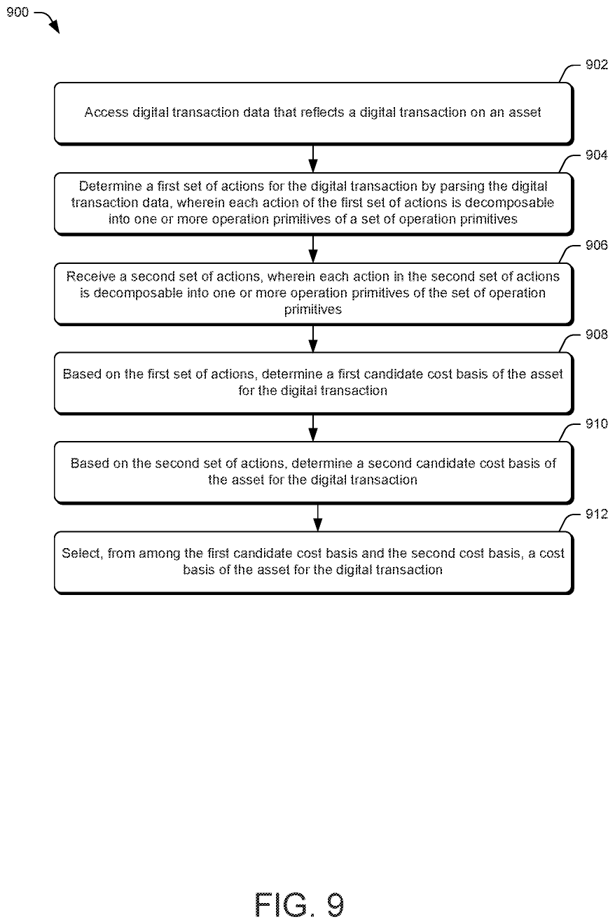

FIG. 9 is a flow diagram of an example procedure 900 for selecting the cost basis for an asset involved in a transaction using different sets of actions to decompose the transaction. In general, the procedure 900 describes the case of representing a transaction involving an asset using different actions. Depending on the actions used to represent the transaction, the procedure 900 may compute different candidate cost bases for the asset. Based on various criteria, the procedure 900 selects a cost basis from the candidate cost bases. The procedure 900 will be described as being performed by the server 104 of FIG. 1 and will include references to components of the FIG. 1. In some implementations, the procedure 900 may be performed by other physical and/or virtual devices.

At block 902, the server 104 may access digital transaction data that reflects a digital transaction on an asset. The digital transaction data may be similar to the data stream in the queue 110. In some implementations, the server 104 accesses the digital transaction data from a distributed ledger, such as a blockchain. In some implementations, the server 104 access the digital transaction data directly from the blockchain. In this case, the server 104 may access the data stored in each block of the blockchain. In some implementations, the server 104 may receive data from a third party device that accesses the distributed ledger. In this case, the data from a third party may be formatted in, for example, a comma separated value file.

At block 904, the server 104 may determine a first set of actions for the digital transaction by parsing the digital transaction data, wherein each action of the first set of actions is decomposable into one or more operation primitives of a set of operation primitives. In some implementations, the data parser module 112 may be configured to select the first set of actions from a set of known actions. The known actions may be stored in the actions storage 113.

At block 906, the server 104 may receive a second set of actions, wherein each action in the second set of actions is decomposable into one or more operation primitives of the set of operation primitives. In some implementations, the second set of actions may be included in the set of known actions. In some implementations, the second set of actions may be generated by the actions generator module 115. In some implementations, the second set of actions may be received from a user.

Each of the actions in the first set of actions, the second set of actions, other actions of the known actions, and other actions generated by the actions generator module 115, other actions received from one or more users, and any other actions may be decomposable into one or more operation primitives. Similar to the actions, the operation primitives may be generated by the operation generator module 136, received from a user, received from a computing device, and/or another other similar source. In some implementations, the operation generator module 136 may determine that an action is not decomposable into the known operation primitives. In this case, the operation generator module 136 may generate and/or request additional operation primitives.

At block 908, based on the first set of actions, the server 104 may determine a first candidate cost basis of the asset for the digital transaction. The cost basis determination may use any of the various techniques described above, such as FIFO, LIFO, specific identification, or any other similar technique.

At block 910, based on the second set of actions, the server 104 may determine a second candidate cost basis of the asset for the digital transaction. The cost basis determination may use any of the various techniques described above, such as FIFO, LIFO, specific identification, or any other similar technique. In some implementations, the server 104 may use the same technique for the two cost basis determinations.

At block 912, the server 104 may select, from among the first candidate cost basis and the second cost basis, a cost basis of the asset for the digital transaction. In some implementations, the server 104 selects the lowest candidate cost basis as the cost basis. In some implementations, the transaction may be part of a larger group of transactions. For example, the transaction may be part of multiple transaction for a user or entity. The server 104 may determine the group of actions that represents the multiple transactions and use the cost basis from that group. The server 104 may determine the minimum number of actions that represents the transaction and select the corresponding cost basis. The server 104 may determine the minimum number of actions that represents a group of transactions. In this case, the server 104 may select the cost basis determines using the actions from that minimum number of actions.

In some implementations, the server 104 may access additional digital transaction data that reflects an additional digital transaction on an additional asset. The server 104 may parse the additional digital transaction data. The server 104 may access known actions that include the first set of actions, the second set of actions, and additional actions. The server 104 may determine that actions from the known actions are not capable of representing the additional digital transaction. Based on this determination, the server 104 generates other actions for the additional digital transaction. In some implementations, each action of the other actions for the additional digital transaction are decomposable into one or more operation primitives of the set of operation primitives.

In some implementations, the server 104 may determine that an action of the other actions for the additional digital transaction is not decomposable into one or more operation primitives of the set of operation primitives. Based on determining that the action of the other actions for the additional digital transaction is not decomposable into one or more operation primitives of the set of operation primitives, server 104 generates additional operation primitives. The server 104 includes the additional operation primitives in the set of operation primitives.

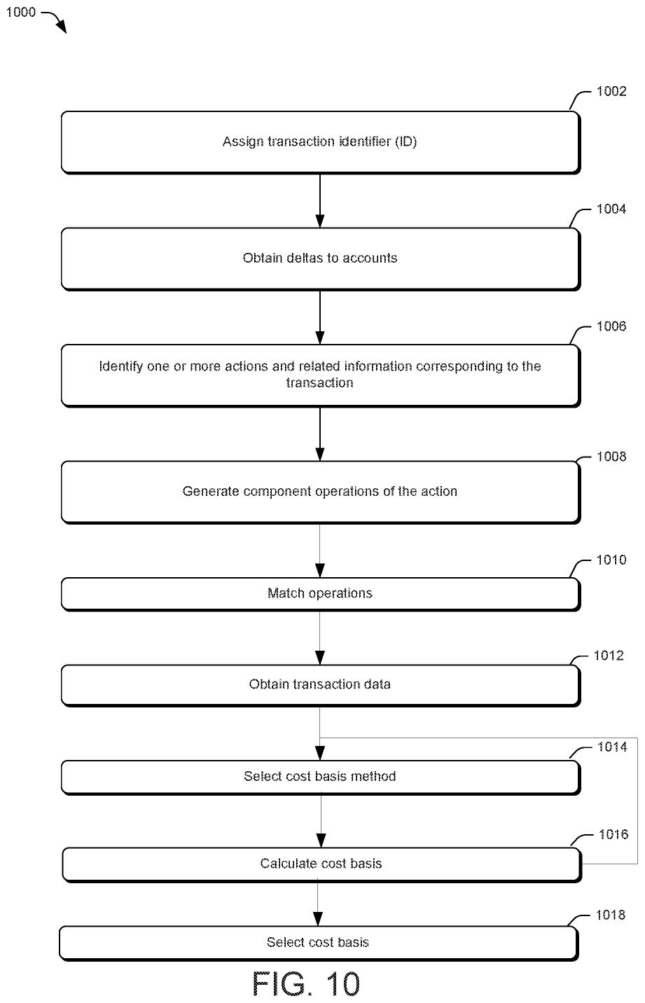

FIG. 10 is a flow diagram of an example procedure 1000 for determining the optimal or near-optimal cost basis for an asset involved in a transaction using different sets of actions to decompose the transaction. In general, the procedure 1000 describes the case of representing a transaction involving an asset using different actions. Depending on the actions used to represent the transaction, the procedure 1000 may compute different candidate cost bases for the asset. Based on various criteria, the procedure 1000 selects a cost basis from the candidate cost bases. The procedure 1000 will be described as being performed by the server 104 of FIG. 1 and will include references to components of the FIG. 1. In some implementations, the procedure 1000 may be performed by other physical and/or virtual devices.

At block 1002, the server 104 may assign a transaction identifier (ID) to the transaction. This transaction identifier is to be distinguished from a transaction identifier that may be assigned to the transaction on the blockchain.

At block 1004, changes (deltas) in account values may be detected and/or obtained, for example by the data parser 562. As described elsewhere herein, the cost basis setting platform 530 of the FTPC server 500 may subscribe to blockchain data in the event streaming platform and utilize the data parser 562 to facilitate the storing of the blockchain data to the database 554. Deltas to the accounts may indicate a transaction, the detection of which may cause the blockchain data describing the transaction to be stored.

At block 1006, the processor(s) 504 may identify one or more actions and related information corresponding to the transaction. For example, a TradeAction may be identified from the obtained deltas. Related information may include, but is not limited to, the transaction ID assigned by the blockchain or exchange, the transaction ID assigned by the host service (server 104), amounts of the transaction (volume and price), parties involved, date and time of the transaction, etc.

At block 1008, the action, specifically the processor(s) 504 that identified the action, may generate component operations of the action. These component operations are the atomic primitive operations described elsewhere herein.

At block 1010, the processor(s) 504 may match the operations generated at block 1008. For example, in the case of a TradeAction, operations BuyOp and SellOp may be generated.

At block 1012, the processor(s) 504 may obtain transaction data corresponding to the action (e.g., the TradeAction) from the blockchain. The transaction data may correspond to one or more items contained in the related information identified at block 1006.

At block 1014, the processor(s) 504 may automatically select a cost basis method to use for calculating a cost basis corresponding to the transaction. For example, example the process 1000 may be configured to select the FIFO method, although any method may be selected.

At block 1016, the processor(s) 504 may calculate the cost basis using the method selected at block 1014. For example, the process 1000 may be configured to calculate a cost basis according to fees associated with the transaction incurred on the purchaser side (which increase the purchase cost), or a cost basis according to fees incurred on the seller side (which reduce the sales proceeds).

After block 1016, the process 1000 may loop back to the block 1014, where the processor(s) may select another cost basis method, such as the LIFO method. Block 1016 may then be performed to calculate the cost basis according to this method. The loop may be repeated for as many cost basis methods as are included in the process 1000.

When all cost basis methods have been performed, the process 1000 may proceed to block 1018, where the processor(s) 504 calculate or cause to calculate the most favorable cost basis to the purchaser of the asset.

Although a few implementations have been described in detail above, other modifications are possible. In addition, the logic flows depicted in the figures do not require the particular order shown, or sequential order, to achieve desirable results. In addition, other actions may be provided, or actions may be eliminated, from the described flows, and other components may be added to, or removed from, the described systems. Accordingly, other implementations are within the scope of the following claims.

What is claimed is:

1. A computer-implemented method, comprising:
assigning, by a computing device, a transaction identifier to a financial transaction on an asset;
identifying an action and related information corresponding to the financial transaction;
generating component operations that effect the action;
matching the component operations to carry out the action;
obtaining transaction data related to the action;
selecting a cost basis method related to one of the operations;
calculating a cost basis for the transaction using the cost basis method;
iterating over the selecting of a cost basis method and calculating a cost basis using the selected cost basis method for a set number of iterations; and
selecting one of the calculated cost basis methods based on a predetermined criterion.

2. The method of claim 1, wherein the transaction data is obtained from a distributed ledger.

3. The method of claim 1, wherein selecting the cost basis includes selecting the largest of the calculated cost bases.

4. The method of claim 1, wherein:
calculating the cost bases is based on operations corresponding to each of the one or more actions, respectively.

5. The method of claim 1, further comprising:
obtaining, by the computing device, additional transaction data that reflects an additional financial transaction on an additional asset;
parsing, by the computing device, the additional financial transaction data;
accessing, by the computing device, known actions that include a first set of actions, a second set of actions, and additional actions;
determining, by the computing device, that actions from the known actions do not represent the parsed additional transaction data; and
based on determining that the actions from the known actions do not represent the parsed additional transaction data, generating, by the computing device, other actions for the additional digital transaction.

6. The method of claim 5, further comprising:
obtaining deltas to accounts from which changes in asset values are reflected in the financial transaction.

7. The method of claim 6, further comprising:
detecting, by the computing device, the deltas to the accounts.

8. A system, comprising:
one or more processors; and
memory including a plurality of computer-executable components that are executable by the one or more processors to perform a plurality of actions, the plurality of actions comprising:
assigning, by a computing device, a transaction identifier to a financial transaction on an asset;
identifying an action and related information corresponding to the financial transaction;
generating component operations that effect the action;
matching the component operations to carry out the action;
obtaining transaction data related to the action;
selecting a cost basis method related to one of the operations;
calculating a cost basis for the transaction using the cost basis;
iterating over the selecting of a cost basis method and calculating a cost basis using the selected cost basis method for a set number of iterations; and
selecting one of the calculated cost basis methods based on a predetermined criterion.

9. The system of claim 8, wherein the transaction data is obtained from a distributed ledger.

10. The system of claim 8, wherein selecting the cost basis includes selecting the largest of the calculated cost bases.

11. The system of claim 8, wherein:
calculating the cost bases is based on operations corresponding to each of the one or more actions, respectively.

12. The system of claim 8, wherein the actions further comprise:
obtaining, by the computing device, additional transaction data that reflects an additional financial transaction on an additional asset;
parsing, by the computing device, the additional financial transaction data;
accessing, by the computing device, known actions that include a first set of actions, a second set of actions, and additional actions;
determining, by the computing device, that actions from the known actions do not represent the parsed additional transaction data; and
based on determining that the actions from the known actions do not represent the parsed additional transaction data, generating, by the computing device, other actions for the additional digital transaction.

13. The system of claim 8, wherein the actions further comprise:
obtaining deltas to accounts from which changes in asset values are reflected in the financial transaction.

14. The system of claim 13, wherein the actions further comprise:
detecting, by the computing device, the deltas to the accounts.

15. One or more non-transitory computer-readable media of a computing device storing computer-executable instructions that upon execution cause one or more computers to perform acts comprising:
assigning, by a computing device, a transaction identifier to a financial transaction on an asset;
identifying an action and related information corresponding to the financial transaction;
generating component operations that effect the action;
matching the component operations to carry out the action;
obtaining transaction data related to the action;
selecting a cost basis method related to one of the operations;
calculating a cost basis for the transaction using the cost basis;
iterating over the selecting of a cost basis method and calculating a cost basis using the selected cost basis method for a set number of iterations; and
selecting one of the calculated cost basis methods based on a predetermined criterion.

16. The one or more non-transitory computer-readable media of claim 15, wherein the transaction data is obtained from a distributed ledger.

17. The one or more non-transitory computer-readable media of claim 15, wherein selecting the cost basis includes selecting the largest of the calculated cost bases.

18. The one or more non-transitory computer-readable media of claim 15, wherein:
calculating the cost bases is based on operations corresponding to each of the one or more actions, respectively.

19. The one or more non-transitory computer-readable media of claim 15, wherein the acts further comprise:
obtaining, by the computing device, additional transaction data that reflects an additional financial transaction on an additional asset;
parsing, by the computing device, the additional financial transaction data;
accessing, by the computing device, known actions that include a first set of actions, a second set of actions, and additional actions;
determining, by the computing device, that actions from the known actions do not represent the parsed additional transaction data; and
based on determining that the actions from the known actions do not represent the parsed additional transaction data, generating, by the computing device, other actions for the additional digital transaction.

20. The one or more non-transitory computer-readable media of claim 19, wherein the acts further comprise:
obtaining deltas to accounts from which changes in asset values are reflected in the financial transaction.
